(19) United States
(12) Patent Application Publication
(10) Pub. No.: US 2020/0082482 A1
(43) Pub. Date: Mar. 12, 2020

(54) METHODS AND SYSTEMS FOR ESTIMATING LEGAL COSTS BASED ON DYNAMIC LEGAL COST ESTIMATION MODELS

(71) Applicants: SHEILA KWAN FAN TAN, LOS ALTOS, CA (US); MICHAEL FROIMOWITZ GREENZEIGER, sunnyvale, CA (US); KEVIN RILEY FAYLE, san francisco, CA (US)

(72) Inventors: SHEILA KWAN FAN TAN, LOS ALTOS, CA (US); MICHAEL FROIMOWITZ GREENZEIGER, sunnyvale, CA (US); KEVIN RILEY FAYLE, san francisco, CA (US)

(21) Appl. No.: 16/352,198

(22) Filed: Mar. 13, 2019

Related U.S. Application Data
(60) Provisional application No. 62/642,570, filed on Mar. 13, 2018.

(51) Int. Cl. G06Q 50/18; G06N 20/00; G06Q 40/00; G06K 9/62

(52) U.S. Cl. CPC G06Q 50/18; G06K 9/6277; G06Q 40/125; G06N 20/00

(57) ABSTRACT

In one aspect, a computerized method for providing an estimated legal cost to a client system based on a dynamic legal cost estimation model including the step of generating a dynamic legal cost estimation model. The method includes the step of determining a set of client-determinant factor parameter values. The method includes the step of generating an estimated legal cost by applying the set of client-determinant factor parameter values to the dynamic legal cost estimation model. The method includes the step of providing an estimated legal cost to the client system. The method includes the step of receiving an actual outcome input from the client system. The method includes the step of modifying the dynamic legal cost estimation model based on the actual outcome input.

### CLAIM OF PRIORITY AND INCORPORATION BY REFERENCE

This application claims priority from U.S. Provisional Application No. 62/642,570, filed 13 Mar. 2018. These applications are hereby incorporated by reference in their entirety for all purposes.

### FIELD OF THE INVENTION

The invention is in the field of machine learning and system optimization and more specifically to a method, system and apparatus for estimating legal costs based on dynamic legal cost estimation models.

### DESCRIPTION OF THE RELATED ART

Recent years have seen an increase in the cost of legal proceedings and attorney fees. Divorce, in particular, can be financially catastrophic for spouses. Sometimes, these cost can be decreased via self-representation and amicable proceedings. However, the difference in the legal costs between various types of divorce proceedings is often unknown to spouses.

At the same time, computer implemented techniques, such as those found in machine learning and data science, have improved and models can be developed to predict future costs. Accordingly, improvements to methods of estimating and displaying possible legal costs of divorces are desired to better inform participants in divorce proceedings.

### SUMMARY

In one aspect, a computerized method for providing an estimated legal cost to a client system based on a dynamic legal cost estimation model including the step of generating a dynamic legal cost estimation model. The method includes the step of determining a set of client-determinant factor parameter values. The method includes the step of generating an estimated legal cost by applying the set of client-determinant factor parameter values to the dynamic legal cost estimation model. The method includes the step of providing an estimated legal cost to the client system. The method includes the step of receiving an actual outcome input from the client system. The method includes the step of modifying the dynamic legal cost estimation model based on the actual outcome input.

### BRIEF DESCRIPTION OF THE DRAWINGS

The present application can be best understood by reference to the following description taken in conjunction with the accompanying figures, in which like parts may be referred to by like numerals.

FIG. 1 depicts a diagram of an example of a system for providing pre-legal-filing self-service and matching of clients and legal practitioners.

FIG. 2 depicts a diagram of an example of an architecture including a dynamic machine-learning-based pre-legal-filing self-service system and a client system.

FIG. 3 depicts a diagram of another example of an architecture including a dynamic machine-learning-based pre-legal-filing self-service system and a client system.

FIG. 4 depicts a diagram of still another example of an architecture including a dynamic machine-learning-based pre-legal-filing self-service system and a client system.

FIG. 5 depicts a diagram of an example of an architecture including a dynamic machine-learning-based pre-legal-filing self-service system, a client system, and a legal practitioner system.

FIG. 6 depicts a diagram of another example of an architecture including a dynamic machine-learning-based pre-legal-filing self-service system, a client system, and a legal practitioner system.

FIG. 7 depicts a diagram of an example of an architecture including a dynamic machine-learning-based pre-legal-filing self-service system, a supplementary support provider system, and a client system.

FIG. 8 depicts a flowchart of an example of a method for providing an estimated legal cost to a client system based on a dynamic legal cost estimation mode.

FIG. 9 depicts a flowchart of an example of a method for providing a settlement plan to a client system based on a dynamic settlement plan generation model.

FIG. 10 depicts a flowchart of an example of a method for providing a legal option presentation to a client system based on a dynamic legal option presentation generation model.

FIG. 11 depicts a flowchart of an example of a method for managing a legal practitioner referral auction.

FIG. 12 depicts a flowchart of an example of a method for managing legal practitioner matching.

FIG. 13 depicts a flowchart of an example of a method for providing supplementary support provider offers to a client system based on a dynamic supplementary support service offer selection model.

FIG. 14 illustrates an example process for providing an estimated legal cost to a client system based on a dynamic legal cost estimation model, according to some embodiments.

FIG. 15 illustrates an example process for generating and utilizing a model for estimating a legal cost, according to some embodiments.

FIG. 16 illustrates an example user-interface display of an estimated legal cost, according to some embodiments.

The Figures described above are a representative set, and are not an exhaustive with respect to embodying the invention.

### DESCRIPTION

Disclosed are a system, method, and article of manufacture of estimating legal costs based on dynamic legal cost estimation models. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Akaike information criterion (AIC) is an estimator of the relative quality of statistical models for a given set of data. Given a collection of models for the data, AIC estimates the quality of each model, relative to each of the other models. In this way, AIC provides a means for model selection.

Data transformation is the application of a deterministic mathematical function to each point in a data set.

Deep learning is a family of machine learning methods based on learning data representations. Learning can be supervised, semi-supervised or unsupervised.

Goodness of fit of a statistical model describes how well it fits a set of observations. Measures of goodness of fit can summarize the discrepancy between observed values and the values expected under the model in question.

Machine learning is a type of artificial intelligence (AI) that provides computers with the ability to learn without being explicitly programmed. Machine learning focuses on the development of computer programs that can teach themselves to grow and change when exposed to new data.

Natural language processing (NLP) is a subfield AI that with the interactions between computers and human (natural) languages and concerns programming computers to process and analyze large amounts of natural language data. NLP can utilize speech recognition, natural language understanding, natural language generation, etc.

Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set.

Exemplary Systems and Methods

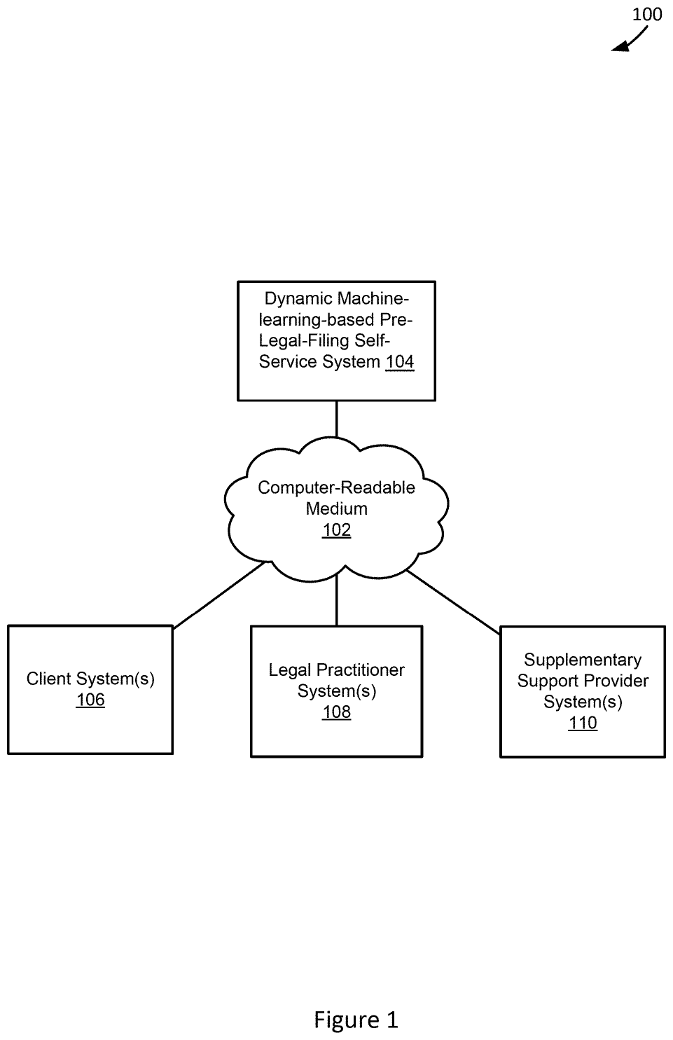

FIG. 1 depicts a diagram 100 of an example of a system for providing pre-legal-filing self-service and matching of clients and legal practitioners. The system of the example of FIG. 1 includes a computer-readable medium 102, a dynamic machine-learning-based pre-legal-filing self-service system 104 coupled to the computer-readable medium 102, one or more client systems 106 coupled to the computer-readable medium 102, one or more legal practitioner systems 108 coupled to the computer-readable medium 102, and one or more supplementary support provider systems 110 coupled to the computer-readable medium 102.

As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the dynamic addiction diagnosis model providing system 104, the dynamic addiction treatment content providing system 106, the client systems 108, and other applicable systems or devices described in this paper can be implemented as a computer system, a plurality of computer systems, or parts of a computer system or a plurality of computer systems. In general, a computer system will include a processor, memory, non-volatile storage, and an interface and the examples described in this paper assume a stored program architecture, though that is not an explicit requirement of the machine. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. A typical CPU includes a control unit, arithmetic logic unit (ALU), and memory (generally including a special group of memory cells called registers).

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

In stored program architectures, software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the dynamic machine-learning-based pre-legal-filing self-service system 104 is intended to represent hardware configured to provide dynamic machine-learning-based pre-legal-filing self-service to the client system(s) 106. In a specific implementation, the dynamic machine-learning-based pre-legal-filing self-service includes a plurality of services including a legal cost estimation, a settlement plan, a legal option presentation, a legal referral auction, a legal practitioner matching, and a supplementary support service offer, and so on.

In a specific implementation, in providing a legal cost estimation, the dynamic machine-learning-based pre-legal-filing self-service system 104 is configured to generate a dynamic legal cost estimation model. As used in this paper, a model is intended to mean a machine learning model artifact data structure created by a machine learning training process, though it should be understood, a model could be replaced with a static data structure to serve as a placeholder until a model can be trained, which can be referred to as a “static” model when a machine learning model artifact data structure and a non-machine learning data structure are distinguished from one another. In a specific implementation, the dynamic legal cost estimation model is configured to output a specific legal cost estimation based on client's input including client-specific information regarding legal issues and facts as client's determinant factor parameters. In a specific implementation, in providing a legal cost estimation, the dynamic machine-learning-based pre-legal-filing self-service system 104 is configured to further generate an estimated legal cost by applying client's determinant factor parameter values to the dynamic legal cost estimation model. In a specific implementation, the estimated legal cost may indicate an estimated legal cost and/or cost range, an estimated time amount and/or amount range for representation of the client, and/or an estimated unit time cost and/or cost range for the representation.

Further, in a specific implementation, in providing a legal cost estimation, the dynamic machine-learning-based pre-legal-filing self-service system 104 is configured to send an estimated legal cost to the client system(s) 106 such that the client system(s) 106 present the estimated legal cost to a client. As used in this paper, a client is a person seeking self-service, or a human or artificial agent thereof. In a specific implementation, in providing a legal cost estimation, the dynamic machine-learning-based pre-legal-filing self-service system 104 is configured to receive actual outcome input from the client system(s) 106. For example, a client could enter feedback, the client system(s) 106 could provide feedback, or results can be obtained from a third-party site regarding relevant legal status associated with a client. In a specific implementation, the actual outcome input may include an actual legal cost incurred, an actual time amount required for representation, an actual unit time cost charged for the representation, and variance of client-specific information during the representation of the client. In a specific implementation, in providing a legal cost estimation, the dynamic machine-learning-based pre-legal-filing self-service system 104 is configured to modify the dynamic legal cost estimation model based on the actual outcome input. In a specific implementation, modification of the dynamic legal cost estimation model includes modification of parameter weight balancing based on an applicable machine learning technique.

In a specific implementation, in providing a settlement plan, the dynamic machine-learning-based pre-legal-filing self-service system 104 is configured to generate a dynamic settlement plan generation model. In a specific implementation, the dynamic settlement plan generation model is configured to output a specific settlement plan based on client's input including client-specific information regarding legal issues and facts as client's determinant factor parameters, and previous settlement records. In a specific implementation, in providing a settlement plan, the dynamic machine-learning-based pre-legal-filing self-service system 104 is configured to further generate a settlement plan by applying client's determinant factor parameter values to the dynamic settlement plan generation model. In a specific implementation, the settlement plan may include an asset distribution, a specific performance to be performed by parties, a specific restriction (e.g., injunctive restriction) to be followed by parties, and so on.

Further, in a specific implementation, in providing a settlement plan, the dynamic machine-learning-based pre-legal-filing self-service system 104 is configured to send settlement plan to the client system(s) 106 such that the client system(s) 106 present the settlement plan to the client. In a specific implementation, in providing a settlement plan, the dynamic machine-learning-based pre-legal-filing self-service system 104 is configured to receive actual outcome input from the client system(s) 106. In a specific implementation, the actual outcome input may include an actual asset distribution settled by parties, actual performances required by parties, actual restrictions to be followed by parties, and so on. In a specific implementation, in providing a settlement plan, the dynamic machine-learning-based pre-legal-filing self-service system 104 is configured to modify the dynamic settlement plan generation model based on the actual outcome input. In a specific implementation, modification of the settlement plan generation model includes modification of parameter weight balancing based on an applicable machine learning technique.

In a specific implementation, in providing a legal option presentation, the dynamic machine-learning-based pre-legal-filing self-service system 104 is configured to generate a dynamic legal option presentation model. In a specific implementation, the dynamic legal option presentation model is configured to output a specific legal option presentation based on client input including client-specific information regarding legal issues and facts as client's determinant factor parameters, and optionally an estimated legal cost and/or a settlement plan obtained by the dynamic machine-learning-based pre-legal-filing self-service system 104. In a specific implementation, in providing a legal option presentation, the dynamic machine-learning-based pre-legal-filing self-service system 104 is configured to generate a legal option presentation by applying client's determinant factor parameter values, and optionally the estimated legal cost and/or the settlement plan, to the dynamic legal option presentation model. In a specific implementation, the legal option presentation may include a suggested legal options including use or non-use of legal practitioners (e.g., lawyers, arbitrators, mediators, etc.), limited or full representation by lawyers, types of legal proceeding (e.g., lawsuit, arbitration, mediation, settlement, etc.), and so on.

Further, in a specific implementation, in providing a legal option presentation, the dynamic machine-learning-based pre-legal-filing self-service system 104 is configured to send a legal option presentation to the client system(s) 106 such that the client system(s) 106 present the legal option presentation to the client. In a specific implementation, in providing a legal option presentation, the dynamic machine-learning-based pre-legal-filing self-service system 104 is configured to receive user selection input from the client system(s) 106. In a specific implementation, the user selection input may indicate which legal option the client selected. In a specific implementation, in providing a legal option presentation, the dynamic machine-learning-based pre-legal-filing self-service system 104 is configured to modify the dynamic legal option presentation model based on the user selection input. In a specific implementation, modification of the dynamic legal option presentation model includes modification of parameter weight balancing based on an applicable machine learning technique.

In a specific implementation, in providing a legal referral auction, the dynamic machine-learning-based pre-legal-filing self-service system 104 is configured to generate and process a legal practitioner referral auction instance. In processing legal practitioner referral auction instance, the dynamic machine-learning-based pre-legal-filing self-service system 104 obtains a client record, determines an estimated legal cost, and determines a client's request parameter values (e.g., budget range). Further, in processing legal practitioner referral auction instance, the dynamic machine-learning-based pre-legal-filing self-service system 104 obtains practitioner records of registered practitioners, and determines potential practitioner candidates based on the practitioner records, the estimated legal cost, the client record, and the request parameter values. Further, in processing legal practitioner referral auction instance, the dynamic machine-learning-based pre-legal-filing self-service system 104 provides auction data (e.g., an auction invitation and a summary of a client record) to the potential practitioner candidates and receives one or more bids from one or more of the potential practitioner candidates.

Further, in processing legal practitioner referral auction instance, the dynamic machine-learning-based pre-legal-filing self-service system 104 determines one or more winning practitioner candidates based on the one or more bids, and sends information of the winning practitioner candidates to the client system(s) 106. Then, the dynamic machine-learning-based pre-legal-filing self-service system 104 receives user selection input to select a legal practitioner (selected practitioner) among the one or more winning practitioner candidates. Upon the selection of the legal practitioner, the dynamic machine-learning-based pre-legal-filing self-service system 104 requests a referral fee payment to a legal practitioner system 108 associated with the selected practitioner, and sends a client record to the legal practitioner system 108 upon payment of the referral fee.

In a specific implementation, in providing a legal practitioner matching, the dynamic machine-learning-based pre-legal-filing self-service system 104 is configured to generate and process a legal practitioner matching instance. In processing legal practitioner matching instance, the dynamic machine-learning-based pre-legal-filing self-service system 104 obtains a client record and determines a fixed legal cost based on the client record. Further, in processing legal practitioner matching instance, the dynamic machine-learning-based pre-legal-filing self-service system 104 obtains practitioner records of registered practitioners, and determines potential practitioner candidates based on the practitioner records, the fixed legal cost, and the client record. Further, in processing legal practitioner matching instance, the dynamic machine-learning-based pre-legal-filing self-service system 104 sends information of the potential practitioner candidates to the client system(s) 106. Then, the dynamic machine-learning-based pre-legal-filing self-service system 104 receives user selection input to select a legal practitioner (selected practitioner) among the one or more potential practitioner candidates. Upon the selection of the legal practitioner, the dynamic machine-learning-based pre-legal-filing self-service system 104 requests a referral fee payment to a legal practitioner system 108 associated with the selected practitioner, and sends a client record to the legal practitioner system 108 upon payment of the referral fee.

In a specific implementation, in providing a supplementary support service offer, the dynamic machine-learning-based pre-legal-filing self-service system 104 is configured to generate a dynamic supplementary support service offer selection model. In a specific implementation, the dynamic supplementary support service offer selection model is configured to output a specific supplementary support service offer based on client's input including client-specific information regarding legal issues and facts as client's determinant factor parameters, a client's legal and/or psychological process stage, supplementary support provider records, and previous offer outcome records.

In a specific implementation, in providing a supplementary support service offer, the dynamic machine-learning-based pre-legal-filing self-service system 104 is configured to generate a supplementary support service offer by applying client's determinant factor parameter values, the client's legal and/or psychological process stage, the supplementary support provider records, and the previous offer outcome records to the dynamic supplementary support service offer selection model. In a specific implementation, the supplementary support service offer may include a service offer for a financial service (e.g., loan), a psychological health consultation, a medical consultation, name change, new credit card applications, parenting plans, a partner matching service a relocation service, a housing service, and so on.

Further, in a specific implementation, in providing a supplementary support service offer, the dynamic machine-learning-based pre-legal-filing self-service system 104 is configured to send a supplementary support service offer to the client system(s) 106 such that the client system(s) 106 present the supplementary support service offer to the client. In a specific implementation, in providing a supplementary support service offer, the dynamic machine-learning-based pre-legal-filing self-service system 104 is configured to receive offer outcome associated with the supplementary support service offer. In a specific implementation, the offer outcome may include information to determine whether a client used an offered supplementary support service. In a specific implementation, in providing a supplementary support service offer, the dynamic machine-learning-based pre-legal-filing self-service system 104 is configured to modify the dynamic supplementary support service offer selection model based on the offer outcome. In a specific implementation, modification of the dynamic supplementary support service offer selection model includes modification of parameter weight balancing based on an applicable machine learning technique.

In a specific implementation, the client system(s) 106 are intended to represent hardware configured to receive dynamic machine-learning-based pre-legal-filing self-service from the dynamic machine-learning-based pre-legal-filing self-service system 104. In a specific implementation, in receiving a legal cost estimation, the client system(s) 106 sends client input (e.g., input regarding legal issues and facts) to the dynamic machine-learning-based pre-legal-filing self-service system 104 and receives and presents the legal cost estimation in response. In a specific implementation, in receiving a settlement plan, the client system(s) 106 send client input (e.g., input regarding legal issues and facts) to the dynamic machine-learning-based pre-legal-filing self-service system 104 and receives and presents the settlement plan in response. In a specific implementation, in receiving a legal option presentation, the client system(s) 106 send client input (e.g., input regarding legal issues and facts) to the dynamic machine-learning-based pre-legal-filing self-service system 104 and receives and presents the legal option presentation in response.

In a specific implementation, in using a practitioner referral auction, the client system(s) 106 send client input (e.g., input regarding legal issues and facts) to the dynamic machine-learning-based pre-legal-filing self-service system 104, receives information of one or more winning practitioner candidates from the dynamic machine-learning-based pre-legal-filing self-service system 104, and returns user selection input of one of the one or more winning practitioner candidates as a selected practitioner to whom a referral is provided. In a specific implementation, in using a practitioner matching, the client system(s) 106 send client input (e.g., input regarding legal issues and facts) to the dynamic machine-learning-based pre-legal-filing self-service system 104, receives information of one or more potential practitioner candidates from the dynamic machine-learning-based pre-legal-filing self-service system 104, and returns user selection input of one of the one or more potential practitioner candidates as a selected practitioner to whom the client is matched. In a specific implementation, in receiving a supplementary support service offer, the client system(s) 106 send client input (e.g., input regarding legal issues and facts) to the dynamic machine-learning-based pre-legal-filing self-service system 104 and receives and presents the supplementary support service offer in response.

In a specific implementation, the client system(s) 106 include a system associated with a client and a system associated with an adversary. For example, a client may be a first spouse of a civil union and an adversary may be a second spouse of the civil union. From the perspective of the dynamic machine-learning-based pre-legal-filing self-service system 104, both the client and the adversary may be treated as clients, but the term adversary is used to distinguish a first client from a second client. Advantageously, the client and adversary can make proposals and counter-proposals to one another, as well as comments explaining proposals and counter-proposals. The dynamic machine-learning-based pre-legal-filing self-service system 104 can provide assistance in filling out forms based on answers common to what previous clients have provided via a set of predefined responses that could be ranked, which may include recording a transaction history of proposals and counterproposals and using that data to machine learn automatic mediation. Counter-proposals can be for a single field or, in a specific implementation, multiple fields. For example, a client might propose trading a different settlement of one item of property for another or for a different alimony amount etc.

In a specific implementation, the legal practitioner system 108 is intended to represent hardware configured to receive a legal practitioner referral auction service and/or a legal practitioner matching service. In a specific implementation, in receiving a legal practitioner referral auction service, the legal practitioner system 108 is configured to send practitioner input for a legal practitioner for registration of the legal practitioner on the dynamic machine-learning-based pre-legal-filing self-service system 104, receive auction data from the dynamic machine-learning-based pre-legal-filing self-service system 104 when the legal practitioner is included in one of one or more potential practitioner candidates, and send a bid to the dynamic machine-learning-based pre-legal-filing self-service system 104 in response. In a specific implementation, in receiving a legal practitioner referral auction service, the legal practitioner system 108 is configured to receive a referral fee payment request from the dynamic machine-learning-based pre-legal-filing self-service system 104 when the legal practitioner is selected for referral, and receives a client record upon payment of the referral fee.

In a specific implementation, in receiving a legal practitioner matching service, the legal practitioner system 108 is configured to send practitioner input for a legal practitioner for registration of the legal practitioner on the dynamic machine-learning-based pre-legal-filing self-service system 104, receive a referral fee payment request from the dynamic machine-learning-based pre-legal-filing self-service system 104 when the legal practitioner is selected for matching, and receives a client record upon payment of the referral fee.

In a specific implementation, the supplementary support provider systems 110 is intended to represent hardware configured to receive a supplementary support service offer extension service provided by the dynamic machine-learning-based pre-legal-filing self-service system 104. In a specific implementation, in receiving the supplementary support service offer extension service, the supplementary support provider systems 110 sends provider input for a supplementary support provider for registration of the supplementary support provider on the dynamic machine-learning-based pre-legal-filing self-service system 104, such that the dynamic machine-learning-based pre-legal-filing self-service system 104 provides supplementary support service offers to client systems 106.

In an example of operation of the example system shown in FIG. 1, the dynamic machine-learning-based pre-legal-filing self-service system 104 provides, to the client system(s) 106, a legal cost estimate generated based on a dynamic legal cost estimation model, a settlement plan generated based on a dynamic settlement plan generation model, a legal option presentation generated based on a dynamic legal option presentation model, and/or supplementary support service offers selected based on a dynamic service offer selection model. Further, in an example of operation of the example system shown in FIG. 1, the dynamic machine-learning-based pre-legal-filing self-service system 104 generates and processes a legal practitioner referral auction instance and/or a legal practitioner matching instance. In the example of operation of the example system shown in FIG. 1, the client system(s) 106 send client input and/or client selection input to select a legal practitioner to the dynamic machine-learning-based pre-legal-filing self-service system 104, and receives and presents the legal cost estimate, the settlement plan, the legal option presentation and/or the supplementary support service offers. In the example of operation of the example system shown in FIG. 1, the legal practitioner system 108 sends practitioner input and/or bids for a practitioner referral auction to the dynamic machine-learning-based pre-legal-filing self-service system 104, and receives and presents auction data and/or a client record provided as a part of a legal referral. In the example of operation of the example system shown in FIG. 1, the supplementary support provider system 110 sends provider input to the dynamic machine-learning-based pre-legal-filing self-service system 104.

Advantageously, a dynamic machine-learning-based pre-legal-filing self-service system is capable of providing a dynamic machine-learning-based pre-legal-filing self-service to client system using computer-based machine learning technology. The computer-based machine learning technology enables modification of models to generate more accurate and more effective outputs useful for the clients, including a legal cost estimation, a settlement plan, a legal option presentation, selection of legal practitioners suitable for the clients through auction or matching, and a supplementary service offer.

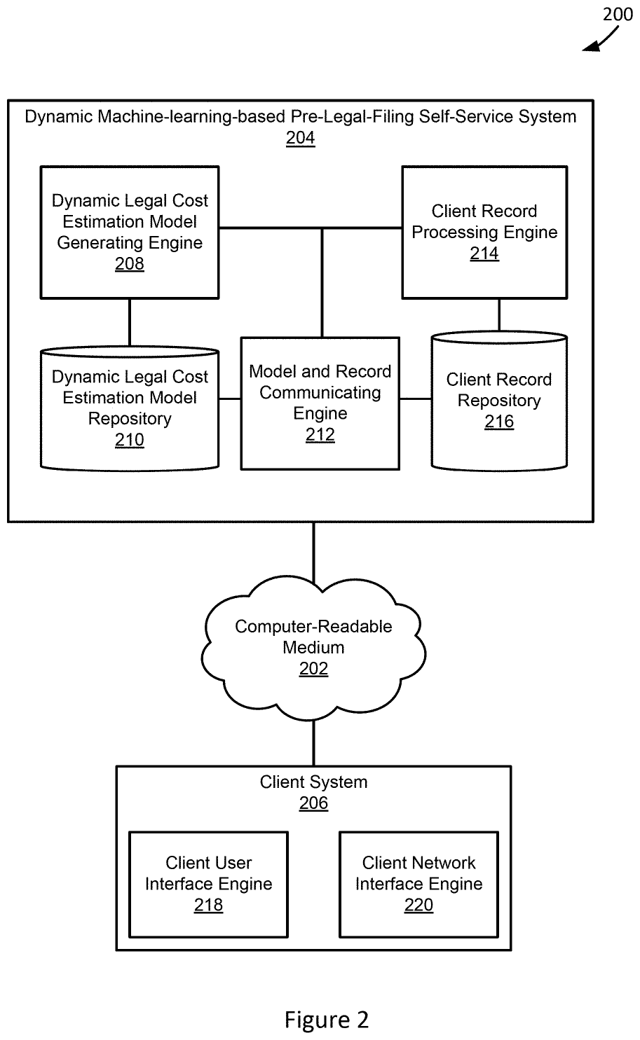

FIG. 2 depicts a diagram 200 of an example of an architecture including a dynamic machine-learning-based pre-legal-filing self-service system and a client system. The diagram 200 includes a computer-readable medium 202, a dynamic machine-learning-based pre-legal-filing self-service system 204 coupled to the computer-readable medium 202 and a client system 206 coupled to the computer-readable medium 202. In a specific implementation, the dynamic machine-learning-based pre-legal-filing self-service system 204 and the client system 206 correspond to the dynamic machine-learning-based pre-legal-filing self-service system 104 and a client system of the client system(s) 106 in FIG. 1, respectively.

The dynamic machine-learning-based pre-legal-filing self-service system 204 is intended to represent hardware configured to manage a dynamic legal cost estimation model and provide a legal cost estimation generated based on the dynamic legal cost estimation model to the client system 206. The dynamic machine-learning-based pre-legal-filing self-service system 204 includes a dynamic legal cost estimation model generating engine 208, a dynamic legal cost estimation model repository 210, a model and record communicating engine 212, a client record processing engine 214, and a client record repository 216. The client system 206 is intended to represent hardware configured to send client input to the dynamic machine-learning-based pre-legal-filing self-service system 204, receive a legal cost estimation from the dynamic machine-learning-based pre-legal-filing self-service system 204, and present the legal cost estimation for a client. The client system 206 includes a client user interface engine 218 and a client network interface engine 220.

The dynamic legal cost estimation model generating engine 208 is intended to represent hardware configured to generate a dynamic legal cost estimation model for generating a legal cost estimation. Depending upon implementation-specific or other considerations, the dynamic legal cost estimation model is configured to output a specific legal cost estimation based on client's input including client-specific information regarding legal issues and facts. In a specific implementation, the legal cost estimation model may include a plurality of parameters for determining a resulting legal cost estimation for a specific client and/or specific legal issues (e.g., divorce, estate planning, probation, etc.), and parameter values of the parameters may be modified through applicable machine learning techniques. In a specific implementation, a first dynamic legal cost estimation model is generated for a first specific legal issue (e.g., divorce), and a second dynamic addiction diagnosis model is generated for a second specific legal issue (e.g., estate planning). Depending upon implementation-specific or other considerations, a legal cost estimation includes a required time amount (e.g., billable hours) for a legal representation of a client by a legal practitioner and an average and/or an assumed hourly rate of legal practitioners in a specific region (e.g., city, county, state, etc.) associated with the client, the legal practitioner, and/or the legal issue and facts.

Depending upon implementation-specific or other considerations, the dynamic legal cost estimation model generating engine 208 generates a dynamic legal cost estimation model based on data from applicable statistic datasources, such as state bar datasources, regional bar association datasources, clinical datasources, law firm datasources, client datasources, and so on. For example, when a correspondence between a specific physical or psychological state of a client (e.g., face image, emotional tension level, etc.) and a required time amount for legal representation for a divorce is known, then the correspondence is taken into consideration in generating the dynamic legal cost estimation model. The specific physical or psychological state of a client may include voluntary expressive features of a client such as a voiceprint of a client, an utterance contents of a client, a facial image of a client, and a text input contents of a client, and so on, and involuntary physical features of a client, and so on. Depending upon implementation-specific or other considerations, the data from applicable data sources may be manually retrieved from the applicable statistic data sources or automatically retrieved therefrom in accordance with applicable triggering events, such as an update thereof. In a specific implementation, the dynamic legal cost estimation model generating engine 208 is configured to store a generated dynamic legal cost estimation model in the dynamic legal cost estimation model repository 210.

The dynamic legal cost estimation model repository 210 is intended to represent a datastore configured to store one or more dynamic legal cost estimation models including one or more dynamic legal cost estimation models generated by the dynamic legal cost estimation model generating engine 208. In a specific implementation, in storing one or more dynamic legal cost estimation models, the dynamic legal cost estimation model repository 210 manages the stored dynamic legal cost estimation models using a dynamic legal cost estimation model table including a plurality of entries each of which corresponds to a dynamic legal cost estimation model. For example, an entry of the dynamic legal cost estimation model table includes an identification of the dynamic legal cost estimation model, an identification of a legal issue, parameter values associated with the dynamic legal cost estimation model table, and stored location information of the dynamic legal cost estimation model. In a specific implementation, in storing one or more legal cost estimation models, the dynamic legal cost estimation model repository 210 also stores a machine learning model applicable to one or more legal cost estimation models stored therein.

In a specific implementation, the dynamic legal cost estimation model generating engine 208 is configured to determine client-determinant factor parameter values based on client input. In a specific implementation, the client-determinant factor parameter values includes a client's legal state (e.g., married, separated, with or without children, number of children, liabilities, duration of marriage, etc.), a client's physical and emotional state (e.g., injured, depressed, etc.), a client's financial state (e.g., with or without income,), and relevant person's (e.g., spouse, children, etc.) legal, physical, emotional, and financial states, in addition to client attributes such as age, gender, residence, employer, financial information (e.g., credit card number), and so on. In a specific implementation, client input is received from the client user interface engine 218 and/or the client network interface engine 220 of the client system 206 and stored in the client record repository 216 as a client record. In a specific implementation, the client-determinant factor parameter values are presented by scalar values, and determined based on the machine learning algorithm.

In a specific implementation, the dynamic legal cost estimation model generating engine 208 is configured to generate an estimated legal cost by applying client-determinant factor parameter values to a dynamic legal cost estimation model. In a specific implementation, an estimated legal cost is calculated by multiplying an estimated time amount required for legal representation of a client, which is calculated based on the dynamic legal cost estimation model, with an estimated unit time rate (e.g., hourly rate) in a specific geographic region (e.g., city, county, state, etc.) and for a specific legal field (e.g., divorce, estate planning, child custody, etc.). In a specific implementation, the estimated legal cost may include a range of estimated costs, a range of estimated time amount, and/or a range of estimated unit time rate, and so on, in addition or instead of a single estimated cost, a single estimated time amount, and/or a single estimate unit time rate (e.g., average rate). In a specific implementation, the dynamic legal cost estimation model generating engine 208 is configured to provide the generated estimated legal cost to the client system 206 through the model and record communicating engine 212.

In a specific implementation, the dynamic legal cost estimation model generating engine 208 is configured to receive actual outcome input from the client system 206, and modifies a dynamic legal cost estimation model based on the actual outcome input. In a specific implementation, the actual outcome input include an actual time amount required for a legal representation, an actual unit time rate billed for the legal representation, any modification of client's determinant factor parameter values during the legal representation, and so on. In a specific implementation, the dynamic legal cost estimation model generating engine 208 modifies the dynamic legal cost estimation model used for generating an estimated legal cost for the legal representation based on one or more of the actual time amount required for the legal representation, the actual unit time rate billed for the legal representation, any modification of client-determinant factor parameter values during the legal representation, and so on, for example, by changing parameter weight balance of a machine learning algorithm. In a specific implementation, the actual outcome also causes update of a client record for the corresponding client.

The model and record communicating engine 212 is intended to represent hardware configured to perform data communication between the dynamic machine-learning-based pre-legal-filing self-service system 204 and the client system 206. In a specific implementation, the model and record communicating engine 212 sends an estimated legal cost from the dynamic machine-learning-based pre-legal-filing self-service system 204 to the client system 206. In a specific implementation, the model and record communicating engine 212 sends client's input and/or actual outcome input from the client system 206 to the dynamic machine-learning-based pre-legal-filing self-service system 204.

The client record processing engine 214 is intended to represent hardware configured to generate a client record based on client input received from the client user interface engine 218 and/or the client network interface engine 220 through the model and record communicating engine 212, and stores the generated client record in the client record repository 216. In a specific implementation, the client input include information about a client's attributes and legal, physical, emotional, and financial states.

The client record repository 216 is intended to represent a datastore configured to store one or more client records including one or more client records generated by the client record processing engine 214. In a specific implementation, in storing one or more client records, the client record repository 216 manages the client records using a client record table including a plurality of entries each of which corresponds to a client record. For example, an entry of the client record table includes an identification of the client record, an identification of a client, data and/or classification of the client's legal, physical, emotional, and/or financial states, data and/or classification of the client's attributes, data and/or classification of legal issues and facts, data and/or classification of an estimated legal cost, if any, and data and/or classification of an actual legal cost, if any, and so on. In a specific implementation, in storing one or more client records, the client record repository 216 also stores a machine learning model applicable to one or more client records stored therein.

The client user interface engine 218 is intended to represent hardware configured to receive and forward client input to the dynamic machine-learning-based pre-legal-filing self-service system 204, and receive and present presentation data received from the dynamic machine-learning-based pre-legal-filing self-service system 204. In a specific implementation, the client user interface engine 218 generates a graphic user interface (GUI) to receive client input, for example, regarding the client's attributes and legal, physical, emotional, and financial states, and processes and forwards received client's input to the dynamic machine-learning-based pre-legal-filing self-service system 204 through the model and record communicating engine 212 thereof. In a specific implementation, the client user interface engine 218 receives an estimated legal cost from the model and record communicating engine 212, and generates a GUI to present the received estimated legal cost. Depending upon implementation-specific or other considerations, the GUI to receive the client's input and/or the GUI to present the estimated legal cost may employ applicable GUI formats, such as graphs, lists, animations, photo images, and so on.

The client network interface engine 220 is intended to represent hardware configured to receive and forward client input to the dynamic machine-learning-based pre-legal-filing self-service system 204, and receive and forward presentation data received from the dynamic machine-learning-based pre-legal-filing self-service system 204. In a specific implementation, the client network interface engine 220 communicates with an external client device associated with the client system 206 and serves as an intermediary between the dynamic machine-learning-based pre-legal-filing self-service system 204 and the external client device. In a specific implementation, the external client device may include applicable devices, such as a smartphone, smart watch, tablet, laptop, desktop computer, smart speaker, smart TV, and other IoT devices, etc. In such a case, the external client device can include the client user interface engine 218.

In an example of operation of the example system shown in FIG. 2, the dynamic legal cost estimation model generating engine 208 generates a dynamic legal cost estimation model, and stores the generated dynamic legal cost estimation model in the dynamic legal cost estimation model repository 210. Further, in the example of operation of the example system shown in FIG. 2, the dynamic legal cost estimation model generating engine 208 determines client's determinant factor parameter values based on client's input received from the client user interface engine 218 and/or the client network interface engine 220 through the model and record communicating engine 212, and a client record stored in the client record repository 216. Furthermore, in the example of operation of the example system shown in FIG. 2, the dynamic legal cost estimation model generating engine 208 generates an estimated legal cost by applying client's determinant factor parameter values and/or the client record to the dynamic legal cost estimation model. Moreover, in the example of operation of the example system shown in FIG. 2, the dynamic legal cost estimation model generating engine 208 provides an estimated legal cost to the client system 206, such that the estimated legal cost is presented on the client system 206, receives actual outcome input from the client system 206, and modifies the dynamic legal cost estimation model based on the actual outcome input. In the example of operation of the example system shown in FIG. 2, the client record processing engine 214 generates a client record based on client's input received from the client user interface engine 218 and/or the client network interface engine 220 through the model and record communicating engine 212, and stores the generated client record in the client record repository 216.

In the example of operation of the example system shown in FIG. 2, the client user interface engine 218 receives client input and forwards the received client input to the dynamic machine-learning-based pre-legal-filing self-service system 204 through the model and record communicating engine 212 thereof. Further, in the example of operation of the example system shown in FIG. 2, the client user interface engine 218 presents the estimated legal cost received from the dynamic machine-learning-based pre-legal-filing self-service system 204 on a GUI generated thereby. In the example of operation of the example system shown in FIG. 2, the client network interface engine 220 receives client input and forwards the received client input to the dynamic machine-learning-based pre-legal-filing self-service system 204 through the model and record communicating engine 212 thereof. Further, in the example of operation of the example system shown in FIG. 2, the client network interface engine 220 forwards the estimated legal cost received from the dynamic machine-learning-based pre-legal-filing self-service system 204 for display on a GUI generated by a coupled user device.

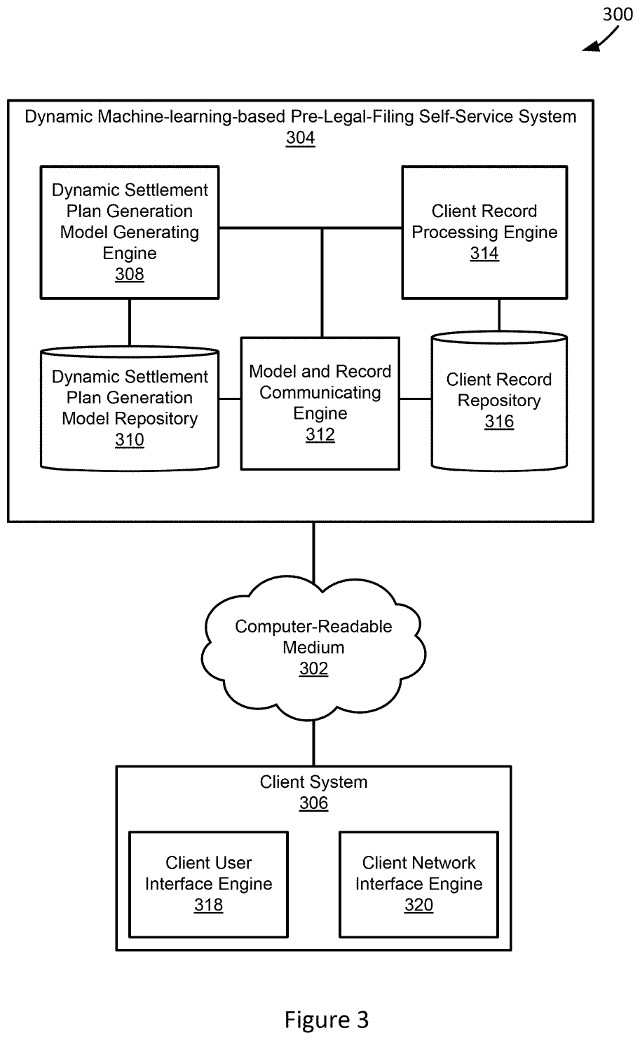

FIG. 3 depicts a diagram 300 of another example of an architecture including a dynamic machine-learning-based pre-legal-filing self-service system and a client system. The example architecture shown in FIG. 3 includes a computer-readable medium 302, a dynamic machine-learning-based pre-legal-filing self-service system 304, and a client system 306. In the example system shown in FIG. 3, the dynamic machine-learning-based pre-legal-filing self-service system 304 and the client system 306 are coupled to each other through the computer-readable medium 302. In a specific implementation, the dynamic machine-learning-based pre-legal-filing self-service system 304 and the client system 306 correspond to the dynamic machine-learning-based pre-legal-filing self-service system 104 and the client system(s) 106 in FIG. 1, respectively, and/or the dynamic machine-learning-based pre-legal-filing self-service system 204 and the client system 206 in FIG. 2, respectively.

The dynamic machine-learning-based pre-legal-filing self-service system 304 is intended to represent hardware configured to manage a dynamic settlement plan generation model and provide a settlement plan generated based on the dynamic settlement plan generation model to the client system 306. The dynamic machine-learning-based pre-legal-filing self-service system 304 includes a dynamic settlement plan generation model generating engine 308, a dynamic settlement plan generation model repository 310, a model and record communicating engine 312, a client record processing engine 314, and a client record repository 316. In a specific implementation, the model and record communicating engine 312, the client record processing engine 314, and the client record repository 316 correspond to the model and record communicating engine 212, the client record processing engine 214, and the client record repository 216.

The client system 306 is intended to represent hardware configured to send client input to the dynamic machine-learning-based pre-legal-filing self-service system 304, receive a settlement plan from the dynamic machine-learning-based pre-legal-filing self-service system 304, and present the settlement plan for a client. The client system 306 includes a client user interface engine 318 and a client network interface engine 320. In a specific implementation, the client user interface engine 318 and the client network interface engine 320 correspond to the client user interface engine 218 and the client network interface engine 220 in FIG. 2.

The dynamic settlement plan generation model generating engine 308 is intended to represent hardware configured to generate a dynamic settlement plan generation model for generating a settlement plan. Depending upon implementation-specific or other considerations, the settlement plan generation model is configured to output a specific settlement plan based on client input including client-specific information regarding legal issues and facts. In a specific implementation, the settlement plan generation model may include a plurality of parameters for determining a resulting settlement plan for a specific client and/or specific legal issues (e.g., divorce, estate planning, probation, etc.), and parameter values of the parameters may be modified through applicable machine learning techniques. In a specific implementation, a first dynamic legal cost estimation model is generated for a first specific legal issue (e.g., divorce), and a second dynamic addiction diagnosis model is generated for a second specific legal issue (e.g., estate planning). Depending upon implementation-specific or other considerations, a settlement plan includes an asset distribution, a specific performance to be performed by parties, a specific restriction (e.g., injunctive restriction) to be followed by parties, and so on. For example, a settlement plan for a divorce case may include an asset distribution of community property (e.g., house, bank deposit, vehicles, etc.), a child support and/or alimony to be paid, a legal and physical child custody, visitation rules, restraining rules (e.g., stay-away rules), and so on. For example, a settlement plan for a trust and estate dispute case may include an asset distribution of estate property, an asset and/or trust management and maintenance, and so on. In a specific implementation, the dynamic settlement plan generation model generating engine 308 is configured to provide the generated settlement plan to the client system 306 through the model and record communicating engine 312.

Depending upon implementation-specific or other considerations, the dynamic settlement plan generation model generating engine 308 generates a dynamic settlement plan generation model based on data from applicable statistic data sources, such as state bar data sources, regional bar association data sources, clinical datasources, law firm data sources, client datasources, and so on. For example, when a correspondence between a specific legal state of a client (e.g., child custody, etc.) and a specific asset distribution is known, then the correspondence is taken into consideration in generating the dynamic legal cost estimation model. Depending upon implementation-specific or other considerations, the data from applicable data sources may be manually retrieved from the applicable statistic data sources or automatically retrieved therefrom in accordance with applicable triggering events, such as an update thereof. In a specific implementation, the dynamic settlement plan generation model generating engine 308 is configured to store a generated dynamic legal cost estimation model in the dynamic settlement plan generation model repository 310.

The dynamic settlement plan generation model repository 310 is intended to represent a datastore configured to store one or more dynamic settlement plan generation models including one or more dynamic settlement plan generation models generated by the dynamic settlement plan generation model generating engine 308. In a specific implementation, in storing one or more dynamic settlement plan generation models, the dynamic settlement plan generation model repository 310 manages the stored dynamic settlement plan generation models using a dynamic settlement plan generation model table including a plurality of entries, each of which corresponds to a dynamic settlement plan generation model. For example, an entry of the dynamic settlement plan generation model table includes an identification of the dynamic settlement plan generation model, an identification of a legal issue and fact, parameter values associated with the dynamic settlement plan generation model, and stored location information of the dynamic settlement plan generation model. In a specific implementation, in storing one or more dynamic settlement plan generation models, the dynamic settlement plan generation model repository 310 also stores a machine learning model applicable to one or more dynamic settlement plan generation models stored therein.

In a specific implementation, the dynamic settlement plan generation model generating engine 308 is configured to determine client-determinant factor parameter values based on client input. In a specific implementation, the client-determinant factor parameter values includes a client's legal state (e.g., married, separated, with or without children, etc.), a client's physical and emotional state (e.g., injured, depressed, etc.), a client's financial state (e.g., with or without income), and relevant persons' (e.g., spouse, children, etc.) legal, physical, emotional, and financial states, in addition to client attributes such as age, gender, residence, employer, financial information (e.g., credit card number), and so on. In a specific implementation, the client input is received via the client user interface engine 318 and the client network interface engine 320 of the client system 306 and stored in the client record repository 316 as one or more client records. In a specific implementation, the client-determinant factor parameter values are presented by scalar values.

In a specific implementation, the dynamic settlement plan generation model generating engine 308 is configured to obtain previous settlement records having similar client-determinant factor parameter values and having outcome data. The dynamic settlement plan generation model generating engine 308 can obtain the previous settlement records from the client record repository 316.

In a specific implementation, the dynamic settlement plan generation model generating engine 308 is configured to receive actual outcome input from the client system 306 and modify a dynamic settlement plan generation model based on the actual outcome input. In a specific implementation, the actual outcome input includes an actual asset distribution settled by parties, actual performances required by parties, actual restrictions to be followed by parties, and so on. In a specific implementation, the dynamic settlement plan generation model generating engine 308 modifies the dynamic settlement plan generation model used for generating a settlement plan for a legal issue based on one or more of actual asset distribution, actual performance, actual restrictions, any modification of client-determinant factor parameter values during the settlement, and so on, for example, by changing parameter weight balance of a model. In a specific implementation, actual outcome also causes an update of a client record for a corresponding client.

The model and record communicating engine 312, the client record processing engine 314, and the client record repository 316 function in the same or similar manner as the model and record communicating engine 212, the client record processing engine 214, and the client record repository 216 in FIG. 2, respectively, and detailed description thereof is omitted for the sake of brevity.

The client user interface engine 318 and the client network interface engine 320 of the client system 306 function in the similar manner as the client user interface engine 218 and the client network interface engine 220 in FIG. 2, respectively. In a specific implementation, the client user interface engine 318 receives a generated settlement plan from the model and record communicating engine 312 and generates a GUI to present the settlement plan. Depending upon implementation-specific or other considerations, the GUI to present the settlement plan may employ applicable GUI formats, such as graphs, lists, animations, photo images, and so on.

In an example of operation of the example system shown in FIG. 3, the dynamic settlement plan generation model generating engine 308 generates a dynamic settlement plant generation model, and stores the generated dynamic settlement plan generation model in the dynamic settlement plan generation model repository 310. Further, in the example of operation of the example system shown in FIG. 3, the dynamic settlement plan generation model generating engine 308 determines client-determinant factor parameter values based on client input received from the client user interface engine 318 and/or the client network interface engine 320 through the model and record communicating engine 312, and a client record stored in the client record repository 316. Furthermore, in the example of operation of the example system shown in FIG. 3, the dynamic settlement plan generation model generating engine 308 generates a settlement plan by applying client-determinant factor parameter values and/or client records to the dynamic settlement plant generation model. Moreover, in the example of operation of the example system shown in FIG. 3, the dynamic settlement plan generation model generating engine 308 provides a generated settlement plan to the client system 306, such that the estimated legal cost is presented on the client system 306, receives actual outcome input from the client system 306, and modifies the dynamic settlement plan generation model based on the actual outcome input. In the example of operation of the example system shown in FIG. 3, the client record processing engine 314 generates a client record based on client input received from the client user interface engine 318 and/or the client network interface engine 320 through the model and record communicating engine 312, and stores the generated client record in the client record repository 316.

In the example of operation of the example system shown in FIG. 3, the client user interface engine 318 receives client input and forwards the received client input to the dynamic machine-learning-based pre-legal-filing self-service system 304 through the model and record communicating engine 312 thereof. Further, in the example of operation of the example system shown in FIG. 3, the client user interface engine 318 presents the generated settlement plan received from the dynamic machine-learning-based pre-legal-filing self-service system 304 on a GUI generated thereby. In the example of operation of the example system shown in FIG. 3, the client network interface engine 320 receives client input and forwards the received client input to the dynamic machine-learning-based pre-legal-filing self-service system 304 through the model and record communicating engine 312 thereof. Further, in the example of operation of the example system shown in FIG. 3, the client network interface engine 320 forwards the generated settlement plan received from the dynamic machine-learning-based pre-legal-filing self-service system 304 for display on a GUI generated by a coupled user device.

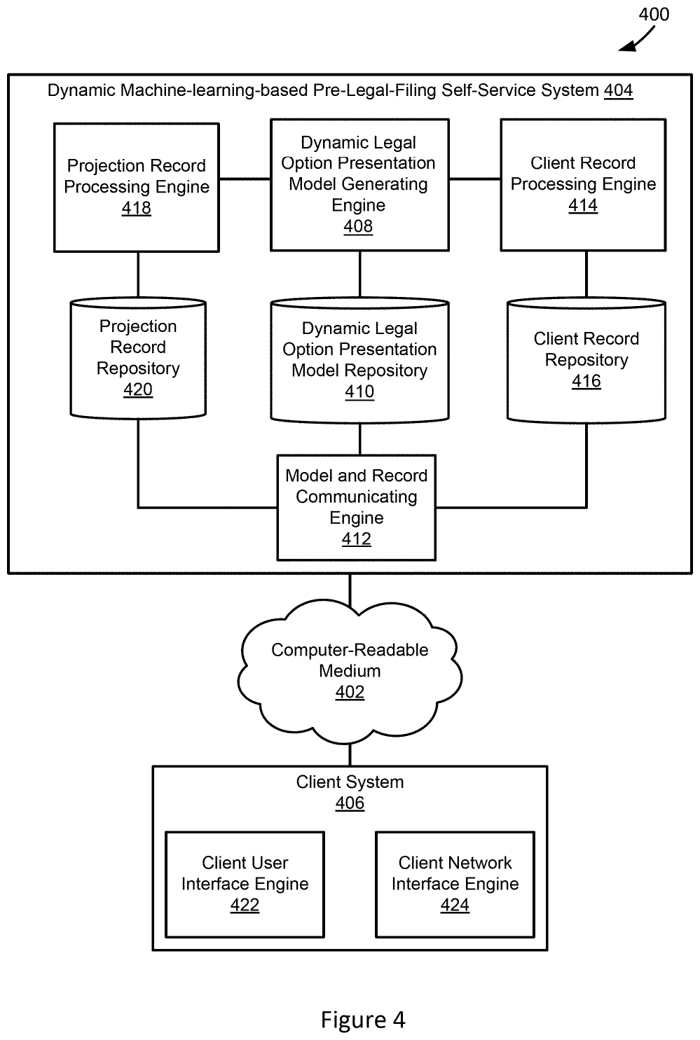

FIG. 4 depicts a diagram 400 of still another example of an architecture including a dynamic machine-learning-based pre-legal-filing self-service system and a client system. The example architecture shown in FIG. 4 includes a computer-readable medium 402, a dynamic machine-learning-based pre-legal-filing self-service system 404, and a client system 406. In the example system shown in FIG. 4, the dynamic machine-learning-based pre-legal-filing self-service system 404 and the client system 406 are coupled to each other through the computer-readable medium 402. In a specific implementation, the dynamic machine-learning-based pre-legal-filing self-service system 404 and the client system 406 correspond to the dynamic machine-learning-based pre-legal-filing self-service system 104, 204, and/or 304 in FIGS. 1-3 and the client system(s) 106, 206, and/or 306 in FIGS. 1-3, respectively.

The dynamic machine-learning-based pre-legal-filing self-service system 404 is intended to represent hardware configured to manage a dynamic legal option presentation model and provide a legal option presentation generated based on the dynamic legal option presentation model to the client system 406. The dynamic machine-learning-based pre-legal-filing self-service system 404 includes a dynamic legal option presentation model generating engine 408, a dynamic legal option presentation model repository 410, a model and record communicating engine 412, a client record processing engine 414, a client record repository 416, a projection record processing engine 418, and a projection record repository 420. In a specific implementation, the model and record communicating engine 412, the client record processing engine 414, and the client record repository 416 correspond to the model and record communicating engine 212, 312, the client record processing engine 214, 314, and the client record repository 216, 316 in FIG. 2-3, respectively. The client system 406 is intended to represent hardware configured to send client input to the dynamic machine-learning-based pre-legal-filing self-service system 404, receive a legal option presentation from the dynamic machine-learning-based pre-legal-filing self-service system 404, and present the legal option presentation for a client. The client system 406 includes a client user interface engine 422 and a client network interface engine 424. In a specific implementation, the client user interface engine 422 and the client network interface engine 424 correspond to the client user interface engine 222, 322 and the client network interface engine 224, 324 in FIGS. 2-3, respectively.

The dynamic legal option presentation model generating engine 408 is intended to represent hardware configured to generate a dynamic legal option presentation model for generating a legal option presentation. Depending upon implementation-specific or other considerations, the dynamic legal option presentation model is configured to output a specific legal option presentation based on client input including client-specific information regarding legal issues and facts, a client record stored in the client record repository 416, and a projection record stored in the projection record repository 420. In a specific implementation, the dynamic legal option presentation model may include a plurality of parameters for determining a legal option presentation for a specific client and/or specific legal issues (e.g., divorce, estate planning, probation, etc.), and parameter values of the parameters may be modified through applicable machine learning techniques. In a specific implementation, a first dynamic legal option presentation model is generated for a first specific legal issue, and a second dynamic legal option presentation model is generated for a second specific legal issue. Depending upon implementation-specific or other considerations, a legal option presentation includes a suggested legal option including use or non-use of legal practitioners (e.g., lawyers, arbitrators, mediators, etc.), limited or full representation by lawyers, types of legal proceeding (e.g., lawsuit, arbitration, mediation, settlement, etc.), and so on.

Depending upon implementation-specific or other considerations, the dynamic legal option presentation model generating engine 408 generates a dynamic legal option presentation model based on data from applicable statistic data sources, such as state bar data sources, regional bar association data sources, clinical datasources, law firm data sources, client datasources, and so on. For example, when a correspondence between a specific physical or psychological state of a client (e.g., emotional tension level, etc.) and a specific legal proceeding type is known, then the correspondence is taken into consideration in generating the dynamic legal option presentation model. The specific physical or psychological state of a client may include voluntary expressive features of a client such as a voiceprint of a client, utterance contents of a client, a facial image of a client, and text input contents of a client, and so on, and involuntary physical features of a client and so on. Depending upon implementation-specific or other considerations, the data from applicable data sources may be manually retrieved from the applicable statistic data sources or automatically retrieved therefrom in accordance with applicable triggering events, such as an update thereof. In a specific implementation, the dynamic legal option presentation model generating engine 408 is configured to store a generated dynamic legal option presentation model in the dynamic legal option presentation model repository 410.

The dynamic legal option presentation model repository 410 is intended to represent a datastore configured to store one or more dynamic legal option presentation models including one or more dynamic legal option presentation models generated by the dynamic legal option presentation model generating engine 408. In a specific implementation, in storing one or more dynamic legal option presentation models, the dynamic legal option presentation model repository 410 manages the stored dynamic legal option presentation models using a dynamic legal option presentation model table including a plurality of entries each of which corresponds to a dynamic legal option presentation model. For example, an entry of the dynamic legal option presentation model table includes an identification of the dynamic legal option presentation model, an identification of a legal issue, parameter values associated with the dynamic legal option presentation model table, and stored location information of the dynamic legal option presentation model. In a specific implementation, in storing one or more dynamic legal option presentation models, the dynamic legal option presentation model repository 410 also stores a machine learning model applicable to one or more dynamic legal option presentation models stored therein.

In a specific implementation, the dynamic legal option presentation model generating engine 408 is configured to determine client-determinant factor parameter values based on client input. In a specific implementation, the client-determinant factor parameter values include a client's legal state (e.g., married, separated, with or without children, etc.), a client's physical and emotional state (e.g., injured, depressed, etc.), a client's financial state (e.g., with or without income), and relevant persons' (e.g., spouse, children, etc.) legal, physical, emotional, and financial states, in addition to client attributes such as age, gender, residence, employer, financial information (e.g., credit card number), and so on. In a specific implementation, the client input is received from the client user interface engine 422 and/or the client network interface engine 424 of the client system 406 and stored in the client record repository 416 as a client record. In a specific implementation, the client-determinant factor parameter values are presented by scalar values.

In a specific implementation, the dynamic legal option presentation model generating engine 408 is configured to obtain an estimated legal cost if a legal practitioner is used, and a settlement plan if a settlement is sought. In a specific implementation, the estimated legal cost is generated or processed by the projection record processing engine 418 and stored in the projection record repository 420 as a portion of a projection record. Similarly, in a specific implementation, the settlement plan is generated or processed by the projection record processing engine 418 and stored in the projection record repository 420 as one or more projection records or a portion of a projection record.

In a specific implementation, the dynamic legal option presentation model generating engine 408 is configured to generate a legal option presentation by applying client-determinant factor parameter values, an estimated legal cost, and/or a settlement plan to a dynamic legal option presentation model. In a specific implementation, a legal option presentation is generated in consideration of an estimated time amount and/or cost required to resolve a case for each of multiple legal proceeding types, a probability of prevailing decisions for each of multiple legal proceeding types, a financial state of a client, an emotional state of the client, and so on. In a specific implementation, the dynamic legal option presentation model generating engine 408 is configured to provide the generated legal option presentation to the client system 406 through the model and record communicating engine 412.

The projection record processing engine 418 is intended to represent hardware configured to process a projection record including an estimated legal cost and/or a settlement plan and manage in the projection record repository 420. In a specific implementation, the estimated legal cost is generated based on a dynamic legal cost estimation model by an applicable engine such as the dynamic legal cost estimation model generating engine 208 in FIG. 2. Similarly, in a specific implementation, the settlement plan is generated based on a dynamic settlement plan generation model by an applicable engine such as the dynamic settlement plan generation model generating engine 308 in FIG. 3.

The projection record repository 420 is intended to represent a datastore configured to store one or more projection records including one or more projection records processed by the projection record processing engine 418. In a specific implementation, in storing one or more projection records, the projection record repository 420 manages the projection records using a projection record table including a plurality of entries each of which corresponds to a projection record. For example, an entry of the projection record table includes an identification of a projection record, an identification of a client, data regarding an estimated legal cost, data regarding a settlement plan, and so on. In a specific implementation, in storing one or more projection records, the projection record repository 420 also stores a machine learning model applicable to one or more projection records stored therein.

The client user interface engine 422 and the client network interface engine 424 of the client system 406 function in a similar manner as the client user interface engine 218 and the client network interface engine 220, respectively, in FIG. 2 and/or the client user interface engine 318 and the client network interface engine 320, respectively, in FIG. 3. In a specific implementation, the client user interface engine 422 receives a generated legal option presentation from the model and record communicating engine 412, and generates a GUI to present the legal option presentation. Depending upon implementation-specific or other considerations, the GUI to present the legal option presentation may employ applicable GUI formats, such as graphs, lists, animations, photo images, and so on.

In an example of operation of the example system shown in FIG. 4, the dynamic legal option presentation model generating engine 408 generates a dynamic legal option presentation model, and stores the generated dynamic legal option presentation model in the dynamic legal option presentation model repository 410. Further, in the example of operation of the example system shown in FIG. 4, the dynamic legal option presentation model generating engine 408 determines client-determinant factor parameter values based on client input received from the client user interface engine 422 and/or the client network interface engine 424 through the model and record communicating engine 412, a client record stored in the client record repository 416, and a projection record including an estimated legal cost and/or a settlement plan stored in the projection record repository 420. Moreover, in the example of operation of the example system shown in FIG. 4, the dynamic legal option presentation model generating engine 408 generates a legal option presentation by applying the client-determinant factor values, the client record, and estimated legal cost and/or settlement plan to the dynamic legal option presentation model. Moreover, in the example of operation of the example system shown in FIG. 4, the dynamic legal option presentation model generating engine 408 provides a legal option presentation to the client system 406, such that the legal option presentation is presented on the client system 406, receives client selection input from the client system 406, and modifies the dynamic legal option presentation model based on the client selection input. In the example of operation of the example system shown in FIG. 4, the client record processing engine 414 generates a client record based on client input received from the client user interface engine 422 and/or the client network interface engine 424 through the model and record communicating engine 412, and stores the generated client record in the client record repository 416. In the example of operation of the example system shown in FIG. 4, the projection record processing engine 418 generates a projection record, including an estimated legal cost and/or a settlement plan, and stores the generated projection record in the projection record repository 420.

In the example of operation of the example system shown in FIG. 4, the client user interface engine 422 receives client input and forwards the received client input to the dynamic machine-learning-based pre-legal-filing self-service system 404 through the model and record communicating engine 412 thereof. Further, in the example of operation of the example system shown in FIG. 4, the client user interface engine 422 presents the generated legal option presentation received from the dynamic machine-learning-based pre-legal-filing self-service system 404 on a GUI generated thereby. In the example of operation of the example system shown in FIG. 4, the client network interface engine 424 receives client input and forwards the received client input to the dynamic machine-learning-based pre-legal-filing self-service system 404 through the model and record communicating engine 412 thereof. Further, in the example of operation of the example system shown in FIG. 4, the client network interface engine 424 forwards the generated legal option presentation received from the dynamic machine-learning-based pre-legal-filing self-service system 404 for display on a GUI generated by a coupled user device.

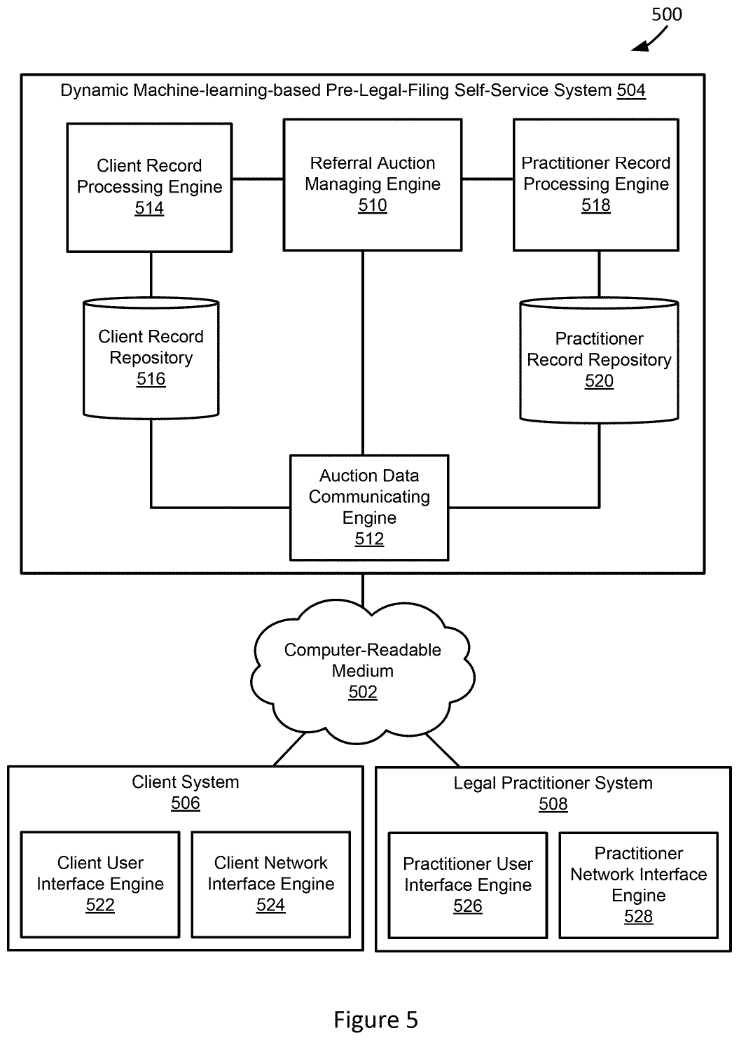

FIG. 5 depicts a diagram 500 of an example of an architecture including a dynamic machine-learning-based pre-legal-filing self-service system, a client system, and a legal practitioner system. The example architecture shown in FIG. 5 includes a computer-readable medium 502, a client system 506, and a legal practitioner system 508. In the example system shown in FIG. 5, the client system 506 and the legal practitioner system 508 are coupled to each other through the computer-readable medium 502. In a specific implementation, the client system 506 and the legal practitioner system 508 correspond to the client system(s) 106, 206, 306, and/or 406 in FIGS. 1-4 and the legal practitioner system 108 in FIG. 1, respectively.

The dynamic machine-learning-based pre-legal-filing self-service system 504 is intended to represent hardware configured to generate and process a legal practitioner referral auction instance. The dynamic machine-learning-based pre-legal-filing self-service system 504 includes a referral auction managing engine 510, an auction data communicating engine 512, a client record processing engine 514, a client record repository 516, a practitioner record processing engine 518, and a practitioner record repository 520. In a specific implementation, the client record processing engine 514 and the client record repository 516 correspond to the client record processing engine 214, 314, and/or 414 in FIGS. 2-4 and the client record repository 216, 316, and/or 416 in FIGS. 2-4, respectively.

The client system 506 is intended to represent hardware configured to send client input to the dynamic machine-learning-based pre-legal-filing self-service system 504, receive and present information of winning practitioner candidates for selection by a client, and send client selection input for selection from the winning practitioner candidates to the dynamic machine-learning-based pre-legal-filing self-service system 504. The client system 506 includes a client user interface engine 522 and a client network interface engine 524. In a specific implementation, the client user interface engine 522 and the client network interface engine 524 correspond to the client user interface engine 218, 318, and/or 422 in FIGS. 2-4 and the client network interface engine 220, 320, and/or 424 in FIGS. 2-4, respectively.

The legal practitioner system 508 is intended to represent hardware configured to receive information of a legal practitioner referral auction instance when a corresponding legal practitioner is selected as a potential practitioner candidate, send a bid for the legal practitioner referral auction instance to the dynamic machine-learning-based pre-legal-filing self-service system 504, and receive a client record corresponding to legal practitioner referral auction instance from the dynamic machine-learning-based pre-legal-filing self-service system 504 when the corresponding legal practitioner is selected for legal representation of the case. The legal practitioner system 508 includes a practitioner user interface engine 526 and a practitioner network interface engine 528.

The referral auction managing engine 510 is intended to represent hardware configured to generate and manage a legal practitioner referral auction instance for selecting a legal practitioner to whom a client's case is referred based on auction. Depending upon implementation-specific or other considerations, the legal practitioner referral auction instance includes one or more potential practitioner candidates to whom invitation to a legal practitioner referral auction is provided based on an estimated legal cost, a client record, client request parameter values, and practitioner records of registered legal practitioners. In a specific implementation, the legal practitioner referral auction instantiation may be based on a plurality of parameters for determining potential practitioner candidates for a specific client, specific legal issues (e.g., divorce, estate planning, probation, etc.), a specific jurisdiction (e.g., state, county, city, etc.), a specific venue and parameter values of the parameters may be modified through applicable machine learning techniques.

In a specific implementation, the referral auction managing engine 510 is configured to obtain a client record from the client record repository 516. In a specific implementation, a client record stored in the client record repository 516 includes a client's legal state (e.g., married, separated, with or without children, etc.), a client's physical and emotional state (e.g., injured, depressed, etc.), a client's financial state (e.g., with or without income), and relevant persons' (e.g., spouse, children, etc.) legal, physical, emotional, and financial states, in addition to client attributes such as age, gender, residence, employer, financial information (e.g., credit card number), and so on.

In a specific implementation, the referral auction managing engine 510 is configured to determine client request parameter values based on client input. In a specific implementation, the client request parameter values include a requested budget (or budget range) for a legal representation, a requested deadline, a request for an alternative fee agreement (e.g., contingent basis fee), and/or a residence (or jurisdiction). In a specific implementation, the client input is received from the client user interface engine 522 and/or the client network interface engine 524 of the client system 506.

In a specific implementation, the referral auction managing engine 510 is configured to obtain practitioner records of registered legal practitioner from the practitioner record repository 520. In a specific implementation, a practitioner record stored in the practitioner record repository 520 includes one or more legal practice fields (e.g., divorce, estate planning, etc.), one or more licensed jurisdictions (e.g., state, courts, etc.), one or more geographical practice regions (e.g., city, county, etc.), a practitioner rating (e.g., made by clients), a fee structure (e.g., hourly rate, whether to accept a fixed fee and/or a contingent-basis fee, etc.), and/or an experience level (e.g., number of years, number of cases, etc.).

In a specific implementation, the referral auction managing engine 510 is configured to provide auction data (e.g., invitation to a legal practitioner referral auction) to the legal practitioner system 508 of a legal practitioner of one or more legal practitioner candidates. In a specific implementation, auction data includes a generic version of a client record (e.g., legal issues) and information about an auction procedure (e.g., limits on bid number, deadline, etc.), information about referral fee for the service, and so on.

In a specific implementation, the referral auction managing engine 510 is configured to receive bids from the legal practitioner system 508 of a legal practitioner of one or more legal practitioner candidates. In a specific implementation, a bid includes an agreed fee amount input by a legal practitioner. In a specific implementation, the referral auction managing engine 510 calculates an adjusted bid amount based on practitioner characteristics of the corresponding legal practitioner (e.g., experience, rating, etc.). For example, as the experience and/or the rating increases, the adjusted bid amount may increase; and as the experience and/or the rating decreases, the adjusted bid amount may decrease. In this case, an actual amount to be charged to a client may not be the bid amount.

In a specific implementation, the referral auction managing engine 510 is configured to select one or more winning legal practitioner candidates based on the bid amount (or the adjusted bid amount). For example, when a plurality of winning practitioner candidates is selected, the referral auction managing engine 510 selects one or more winning legal practitioner candidates of which bid amount is less than a certain threshold (e.g., client's requested value) or of which bid amounts are top lowest amounts (e.g., top three). In another example, when one winning legal practitioner candidate is selected, the referral auction managing engine 510 selects the legal practitioner as the one to whom to send a legal referral.

In a specific implementation, the referral auction managing engine 510 is configured to send information of the winning legal practitioner candidates to the client system 506, to ask for selection of one of a plurality of winning legal practitioner candidates to whom a legal referral is to be sent, and/or an agreement to send a legal referral to the winning legal practitioner candidate. In a specific implementation, the referral auction managing engine 510 is configured to receive client selection input from the client system 506 indicating identification of one legal practitioner candidate to whom the legal referral is to be sent. In a specific implementation, upon reception of the client selection input, the referral auction managing engine 510 sends fee payment information to the legal practitioner system 508 of the selected legal practitioner, and upon payment of a referral fee, sends a legal referral including a client record to the legal practitioner system 508, such that the legal referral including the client record is presented to the selected legal practitioner. In a specific implementation, when sufficient payment is not made by a designated date, the referral auction managing engine 510 selects a second legal practitioner in the bids to whom the legal referral is to be sent, and carries out the same process as with the first legal practitioner candidate.

The practitioner record processing engine 518 is intended to represent hardware configured to generate a practitioner record and manage in the practitioner record repository 520. In a specific implementation, the practitioner record is generated based on practitioner input received by the practitioner user interface engine 526 and/or the practitioner network interface engine 528 of the legal practitioner system 508 and delivered through the auction data communicating engine 512.

The practitioner record repository 520 is intended to represent a datastore configured to store one or more practitioner records including one or more practitioner records processed by the practitioner record processing engine 518. In a specific implementation, in storing one or more practitioner record, the practitioner record repository 520 manages the practitioner records using a practitioner record table including a plurality of entries each of which corresponds to a practitioner record. For example, an entry of the practitioner record table includes an identification of the practitioner record, an identification of a legal practitioner, attributes of the legal practitioner (e.g., jurisdiction, practice area, practice geographic regions, fee structure, experience, rating, etc.), and so on. In a specific implementation, in storing one or more practitioner records, the practitioner record repository 520 also stores a machine learning model applicable to one or more practitioner records stored therein.

The practitioner user interface engine 526 is intended to represent hardware configured to receive and forward practitioner input to the dynamic machine-learning-based pre-legal-filing self-service system 504, and receive and present auction data received from the dynamic machine-learning-based pre-legal-filing self-service system 504. In a specific implementation, the practitioner user interface engine 526 generates a graphical user interface (GUI) to receive practitioner input, for example, regarding practitioner attributes and/or bids, and processes and forwards received practitioner input to the dynamic machine-learning-based pre-legal-filing self-service system 504 through the auction data communicating engine 512 thereof. In a specific implementation, the practitioner user interface engine 526 receives auction data and/or a client record from the auction data communicating engine 512, and generates a GUI to present the received auction data and/or a client record. Depending upon implementation-specific or other considerations, the GUI to receive practitioner input and/or the GUI to present the auction data and/or the client record may employ applicable GUI formats, such as graphs, lists, animations, photo images, and so on.

The practitioner network interface engine 528 is intended to represent hardware configured to receive and forward practitioner input to the dynamic machine-learning-based pre-legal-filing self-service system 504, and receive and forward auction data and/or a client record received from the dynamic machine-learning-based pre-legal-filing self-service system 504. In a specific implementation, the client network interface engine 528 communicates with an external practitioner device associated with the legal practitioner system 508 and serves as an intermediary between the dynamic machine-learning-based pre-legal-filing self-service system 504 and the external practitioner device. In a specific implementation, the external client device may include applicable devices, such as a smartphone, smart watch, tablet, laptop, desktop computer, smart speaker, smart TV, and other IoT devices, etc. In such a case, the external practitioner device includes functions substantially similar to the practitioner user interface engine 526.

In an example of operation of the example system shown in FIG. 5, the referral auction managing engine 510 generates a legal practitioner referral auction instance. Further, in an example of operation of the example system shown in FIG. 5, in the legal practitioner referral auction instance, the referral auction managing engine 510 determines an estimated legal cost and obtains a client record stored in the client record repository 516 and practitioner records of registered legal practitioners stored in the practitioner record repository 520. Moreover, in an example of operation of the example system shown in FIG. 5, the referral auction managing engine 510 determines client request parameter values and determines potential practitioner candidates based on the practitioner records, the estimated legal cost and the client record, and request parameter values. Further, in an example of operation of the example system shown in FIG. 5, the referral auction managing engine 510 provides auction data to the legal practitioner system 508 of a legal practitioner of one or more potential practitioner candidates, and receives bids from the legal practitioner system 508. Further, in an example of operation of the example system shown in FIG. 5, the referral auction managing engine 510 selects winning practitioner candidates, sends information of winning practitioner candidates to the client system 506, and receives client selection input from the client system 506. In an example of operation of the example system shown in FIG. 5, the referral auction managing engine 510 provides a client record to the legal practitioner system 508 of a winning practitioner.

In the example of operation of the example system shown in FIG. 5, the client user interface engine 522 receives client input and forwards the received client input to the dynamic machine-learning-based pre-legal-filing self-service system 504 through the auction data communicating engine 512 thereof. Further, in the example of operation of the example system shown in FIG. 5, the client user interface engine 522 presents the information of winning practitioner candidates received from the dynamic machine-learning-based pre-legal-filing self-service system 504 on a GUI generated thereby. In the example of operation of the example system shown in FIG. 5, the client network interface engine 524 receives client input and forwards the received client input to the dynamic machine-learning-based pre-legal-filing self-service system 504 through the auction data communicating engine 512 thereof. Further, in the example of operation of the example system shown in FIG. 5, the client network interface engine 524 forwards the information of winning practitioner candidates received from the dynamic machine-learning-based pre-legal-filing self-service system 504 for display on a GUI generated by a coupled user device.

In the example of operation of the example system shown in FIG. 5, the practitioner user interface engine 526 receives the auction data from the dynamic machine-learning-based pre-legal-filing self-service system 504 and presents the auction data on a GUI generated thereby. Further, in the example of operation of the example system shown in FIG. 5, the practitioner user interface engine 526 receives bids and forwards bids to the dynamic machine-learning-based pre-legal-filing self-service system 504 through the auction data communicating engine 512 thereof. Moreover, in the example of operation of the example system shown in FIG. 5, the practitioner user interface engine 526 for a winning legal practitioner receives a client record from the dynamic machine-learning-based pre-legal-filing self-service system 504 and presents the client record on a GUI generated thereby. In the example of operation of the example system shown in FIG. 5, the practitioner network interface engine 528 receives the auction data from the dynamic machine-learning-based pre-legal-filing self-service system 504 and forwards the auction data for display on a GUI generated by a coupled user device. Further, in the example of operation of the example system shown in FIG. 5, the practitioner network interface engine 528 receives bids and forwards bids to the dynamic machine-learning-based pre-legal-filing self-service system 504 through the auction data communicating engine 512 thereof. Moreover, in the example of operation of the example system shown in FIG. 5, the practitioner network interface engine 528 for a winning legal practitioner receives a client record from the dynamic machine-learning-based pre-legal-filing self-service system 504 and forwards the client record for display on a GUI generated by a coupled user device.

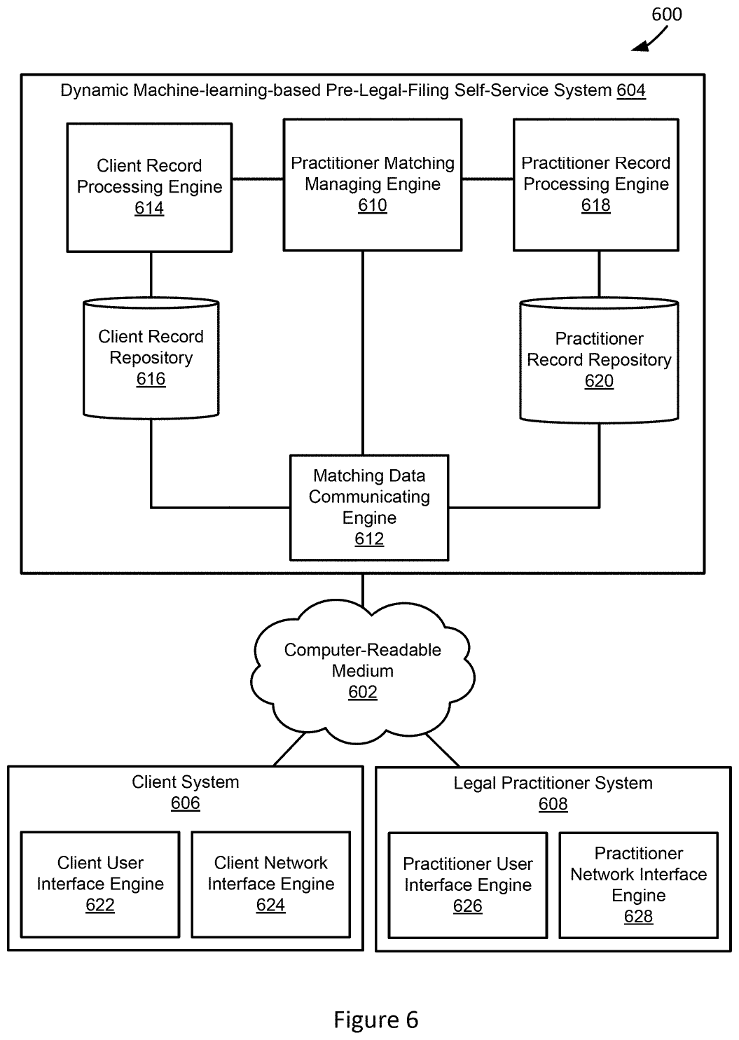

FIG. 6 depicts a diagram 600 of another example of an architecture including a dynamic machine-learning-based pre-legal-filing self-service system, a client system, and a legal practitioner system. The example architecture shown in FIG. 6 includes a computer-readable medium 602, a dynamic machine-learning-based pre-legal-filing self-service system 604, a client system 606, and a legal practitioner system 608. In the example system shown in FIG. 6, the dynamic machine-learning-based pre-legal-filing self-service system 604, the client system 606, and the legal practitioner system 608 are coupled to each other through the computer-readable medium 602. In a specific implementation, the dynamic machine-learning-based pre-legal-filing self-service system 604, the client system 606, and the legal practitioner system 608 correspond to the dynamic machine-learning-based pre-legal-filing self-service system 104, 204, 304, 404, and/or 504 in FIGS. 1-5, the client system(s) 106, 206, 306, 406, and/or 506 in FIGS. 1-5, and the legal practitioner system 108 and/or 508 in FIGS. 1 and 5, respectively.

The dynamic machine-learning-based pre-legal-filing self-service system 604 is intended to represent hardware configured to generate and process a legal practitioner matching instance. The dynamic machine-learning-based pre-legal-filing self-service system 604 includes a practitioner matching managing engine 610, a matching data communicating engine 612, a client record processing engine 614, a client record repository 616, a practitioner record processing engine 618, a practitioner record repository 620. In a specific implementation, the client record processing engine 614, the client record repository 616, the practitioner record processing engine 618, and the practitioner record repository 620 correspond to the client record processing engine 214, 314, 414, and/or 514 in FIGS. 1-5, the client record repository 216, 316, 416, and/or 516 in FIGS. 1-5, the practitioner record processing engine 518 in FIG. 5, and the practitioner record repository 520 in FIG. 5, respectively.

The client system 606 is intended to represent hardware configured to send client input to the dynamic machine-learning-based pre-legal-filing self-service system 604, receive and present information of a selected practitioner from the dynamic machine-learning-based pre-legal-filing self-service system 604. The client system 606 includes a client user interface engine 622 and a client network interface engine 624. In a specific implementation, the client user interface engine 622 and the client network interface engine 624 correspond to the client user interface engine 218, 318, 422, and/or 522 in FIGS. 1-5 and a client network interface engine 220, 320, 424, and/or 524 in FIGS. 1-5, respectively.

The legal practitioner system 608 is intended to represent hardware configured to receive information of a legal practitioner matching instance when a corresponding legal practitioner is selected as a practitioner for sending a legal referral, and receive a client record corresponding to the legal referral from the dynamic machine-learning-based pre-legal-filing self-service system 504 when sufficient referral fee is paid. The legal practitioner system 608 includes a practitioner user interface engine 626 and a practitioner network interface engine 628. In a specific implementation, the practitioner user interface engine 626 and the practitioner network interface engine 628 correspond to the practitioner user interface engine 526 and the practitioner network interface engine 528 in FIG. 5, respectively.

The practitioner matching managing engine 610 is intended to represent hardware configured to generate and manage a legal practitioner matching instance for selecting a legal practitioner to whom a client's case is referred. Depending upon implementation-specific or other considerations, the legal practitioner referral matching instance includes a legal practitioner candidate to whom a legal practitioner referral is provided based on an estimated legal cost, a client record, client's request parameter values, and practitioner records of registered legal practitioners. In a specific implementation, the legal practitioner matching instance may be executed based on a plurality of parameters for determining a legal practitioner for a specific client, specific legal issues (e.g., divorce, estate planning, probation, etc.), a specific jurisdiction (e.g., state, county, city, etc.), a specific venue, and parameter values of the parameters may be modified through applicable machine learning techniques.

In a specific implementation, the practitioner matching managing engine 610 is configured to obtain a client record from the client record repository 616. In a specific implementation, a client record stored in the client record repository 616 includes a client's legal state (e.g., married, separated, with or without children, etc.), a client's physical and emotional state (e.g., injured, depressed, etc.), a client's financial state (e.g., with or without income), and relevant person's (e.g., spouse, children, etc.) legal, physical, emotional, and financial states, in addition to client attributes such as age, gender, residence, employer, financial information (e.g., credit card number), and so on.

In a specific implementation, the practitioner matching managing engine 610 is configured to determine a fixed legal cost for legal representation of a client for a case. In a specific implementation, the fixed legal cost is determined based on an estimated legal cost generated by an applicable engine such as the dynamic legal cost estimation model generating engine 208 in FIG. 2.

In a specific implementation, the practitioner matching managing engine 610 is configured to obtain practitioner records of a registered legal practitioner from the practitioner record repository 620. In a specific implementation, a practitioner record stored in the practitioner record repository 620 includes one or more legal practice fields (e.g., divorce, estate planning, etc.), one or more licensed jurisdictions (e.g., state, courts, etc.), one or more geographical practice regions (e.g., city, county, etc.), a practitioner rating (e.g., made by clients), a fee structure (e.g., hourly rate, whether to accept a fixed fee and/or a contingent-basis fee, etc.), and/or an experience level (e.g., number of years, number of cases, etc.).

In a specific implementation, the practitioner matching managing engine 610 is configured to select one legal practitioner based on the client record, the fixed fee, and the practitioner records. In a specific implementation, the practitioner matching managing engine 610 is configured to send fee payment information to the legal practitioner system 608 of a selected practitioner, and upon payment of a referral fee, to send a legal referral including a client record to the legal practitioner system 608, such that the legal referral including the client record is presented to the selected practitioner. In a specific implementation, when sufficient payment is not made by a designated date, the practitioner matching managing engine 610 repeats selection of a legal practitioner.

In an example of operation of the example system shown in FIG. 6, the practitioner matching managing engine 610 generates a legal practitioner matching instance. Further, in an example of operation of the example system shown in FIG. 6, in the legal practitioner matching instance, the practitioner matching managing engine 610 determines a fixed legal cost based on a client record obtained from the client record repository 616. Moreover, in an example of operation of the example system shown in FIG. 6, the practitioner matching managing engine 610 obtains practitioner records of registered legal practitioners from the practitioner record repository 620, and determines potential practitioner candidates based on practitioner records, the fixed legal cost and the client record. Further, in an example of operation of the example system shown in FIG. 6, the practitioner matching managing engine 610 provides information of the potential practitioner candidates to the client system 606 and receives client selection input from the client system 606. In an example of operation of the example system shown in FIG. 6, the practitioner matching managing engine 610 provides a client record to a practitioner system 608 of a selected practitioner.

Continuing the example of operation of the example system shown in FIG. 6, the client user interface engine 622 receives client input and forwards the received client input to the dynamic machine-learning-based pre-legal-filing self-service system 604 through the matching data communicating engine 612 thereof. Further, in the example of operation of the example system shown in FIG. 6, the client user interface engine 622 presents the information of the potential practitioner candidates received from the dynamic machine-learning-based pre-legal-filing self-service system 604 on a GUI generated thereby. In the example of operation of the example system shown in FIG. 6, the client network interface engine 624 receives client input and forwards the received client input to the dynamic machine-learning-based pre-legal-filing self-service system 604 through the matching data communicating engine 612 thereof. Further, in the example of operation of the example system shown in FIG. 6, the client network interface engine 624 forwards the information of potential practitioner candidates received from the dynamic machine-learning-based pre-legal-filing self-service system 604 for display on a GUI generated by a coupled user device.

Continuing the example of operation of the example system shown in FIG. 6, the practitioner user interface engine 626 for a selected legal practitioner receives a client record from the dynamic machine-learning-based pre-legal-filing self-service system 604 and presents the client record on a GUI generated thereby. In the example of operation of the example system shown in FIG. 6, the practitioner network interface engine 628 for a selected legal practitioner receives a client record from the dynamic machine-learning-based pre-legal-filing self-service system 604 and forwards the client record for display on a GUI generated by a coupled user device.

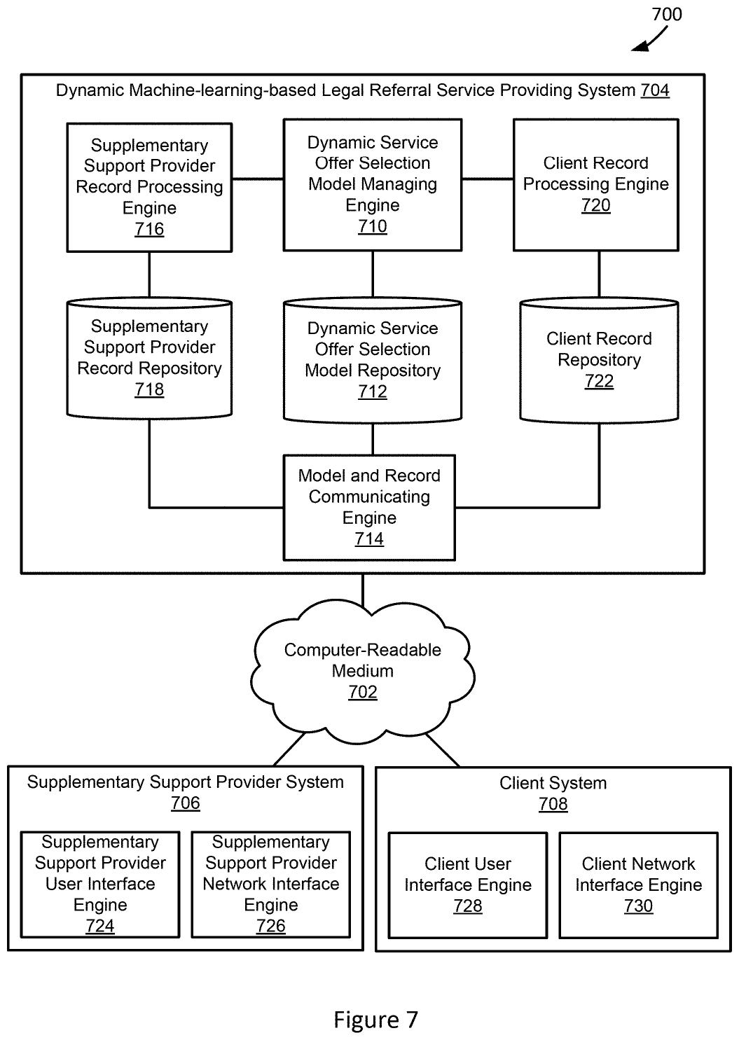

FIG. 7 depicts a diagram 700 of an example of an architecture including a dynamic machine-learning-based pre-legal-filing self-service system, a supplementary support provider system, and a client system. The example architecture shown in FIG. 7 includes a computer-readable medium 702, a dynamic machine-learning-based pre-legal-filing self-service system 704 coupled to the computer-readable medium 702, a supplementary support provider system 706 coupled to the computer-readable medium 702, and a client system 708 coupled to the computer-readable medium 702. In a specific implementation, the dynamic machine-learning-based pre-legal-filing self-service system 704, the supplementary support provider system 706, and the client system 708 correspond to the dynamic machine-learning-based pre-legal-filing self-service system 104, 204, 304, 404, 504, and/or 604 in FIGS. 1-6, the supplementary support provider system 110 in FIG. 1, and the client system(s) 106, 206, 306, 406, 506, and/or 606 in FIGS. 1-6, respectively.

The dynamic machine-learning-based pre-legal-filing self-service system 704 is intended to represent hardware configured to manage a dynamic service offer selection model and provide a supplementary support service offer selected based on the dynamic service offer selection model to the client system 708. The dynamic machine-learning-based pre-legal-filing self-service system 704 includes a dynamic service offer selection model managing engine 710, a dynamic service offer selection model repository 712, a model and record communicating engine 714, a supplementary support provider record processing engine 716, a supplementary support provider record repository 718, a client record processing engine 720, a client record repository 722. In a specific implementation, the model and record communicating engine 714, the client record processing engine 720, and the client record repository 722 correspond to the model and record communicating engine 212, 312, and/or 412 in FIGS. 2-4, the client record processing engine 214, 314, 414, 514, and/or 614 in FIGS. 2-6, and the client record repository 216, 316, 416, 516, and/or 616 in FIGS. 2-6, respectively.

The supplementary support provider system 706 is intended to represent hardware configured to send provider input to the dynamic machine-learning-based pre-legal-filing self-service system 704. The supplementary support provider system 706 includes a supplementary support provider user interface engine 724 and a supplementary support provider network interface engine 726.

The client system 708 is intended to represent hardware configured to send client input to the dynamic machine-learning-based pre-legal-filing self-service system 704, receive supplementary support service offers from the dynamic machine-learning-based pre-legal-filing self-service system 704, and presents the supplementary support service offers for a client. The client system 708 includes a client user interface engine 728 and a client network interface engine 730. In a specific implementation, the client user interface engine 728 and the client network interface engine 730 correspond to the client user interface engine 218, 318, 422, 522, and/or 622 in FIGS. 2-6 and the client network interface engine 220, 320, 424, 524, and/or 624 in FIGS. 2-6, respectively.

The dynamic service offer selection model managing engine 710 is intended to represent hardware configured to generate a dynamic service offer selection model for selecting supplementary support service offers to be extended to the client system 708. Depending upon implementation-specific or other considerations, the dynamic service offer selection model is configured to select supplementary support service offers based on a client record, client input, client legal and/or psychological process stage, supplementary support provider records, and previous offer records. In a specific implementation, the dynamic service offer selection model may include a plurality of parameters for determining a resulting supplementary support service offers for a specific client, and/or specific legal issues (e.g., divorce, estate planning, probation, etc.), and parameter values of the parameters may be modified through applicable machine learning techniques. Depending upon implementation-specific or other considerations, a supplementary support service offer includes a service offer for a financial service (e.g., loan), a psychological health consultation, a medical consultation, name change, new credit card applications, parenting plans, a partner matching service a relocation service, a housing service, and so on.

The dynamic service offer selection model repository 712 is intended to represent datastore configured to store one or more dynamic service offer selection models including one or more dynamic service offer selection models generated by the dynamic service offer selection model managing engine 710. In a specific implementation, in storing one or more dynamic service offer selection models, the dynamic service offer selection model repository 712 manages the stored dynamic service offer selection models using a dynamic service offer selection model table including a plurality of entries each of which corresponds to a dynamic service offer selection model. For example, an entry of the dynamic service offer selection model table includes an identification of the dynamic service offer selection model, an identification of a legal issue, parameter values associated with the dynamic service offer selection model table, and stored location information of the dynamic service offer selection model. In a specific implementation, in storing one or more dynamic service offer selection models, the dynamic service offer selection model repository 712 also stores a machine learning model applicable to one or more dynamic service offer selection models stored therein.

In a specific implementation, the dynamic service offer selection model managing engine 710 is configured to obtain a client record from the client record repository 722 and/or client input from the client user interface engine 728 and/or the client network interface engine 730. In a specific implementation, a client record and/or the client input include information about a client's legal, physical, emotional, and/or financial states, and client attributes.

In a specific implementation, the dynamic service offer selection model managing engine 710 is configured to determine a client's legal and/or psychological process stage based on the client record and/or the client input. In a specific implementation, a client's legal process stage indicates an extent of a legal process that has been implemented and an extent of a remaining legal process, and is expressed by a scalar value (e.g., 1-4). Similarly, in a specific implementation, a client psychological process stage indicates transition of a psychological state to be usually experienced during a course of a legal proceeding.

In a specific implementation, the dynamic service offer selection model managing engine 710 is configured to obtain supplementary support provider records of registered supplementary support providers from the supplementary support provider record repository 718. In a specific implementation, a supplementary support provider record stored in the supplementary support provider record repository 718 includes one or more service fields (e.g., financial, psychological, medical, life support, etc.), one or more service regions (e.g., state, county, city, etc.), a service provider rating (e.g., made by clients), a fee structure, and so on.

In a specific implementation, the dynamic service offer selection model managing engine 710 is configured to obtain previous offer outcome records of supplementary support service offers associated with the client record and/or the client input. In a specific implementation, a previous offer outcome record includes a past conversion rate for supplementary support service offers provided to clients having similar client records.

In a specific implementation, the dynamic service offer selection model managing engine 710 is configured to provide the determined supplementary support service offers to the client system 708 through the model and record communicating engine 714, and receive offer outcome through the model and record communicating engine 714. In a specific implementation, an offer outcome includes information to determine whether a client used an offered supplementary support service, and an offer outcome record is generated based on the offer outcome. In a specific implementation, the dynamic service offer selection model managing engine 710 modifies the dynamic service offer selection model used for selecting one or more supplementary support service offers based on the offer outcome, by changing parameter weight balance of a model.

The supplementary support provider record processing engine 716 is intended to represent hardware configured to generate a supplementary support provider record and manage in the supplementary support provider record repository 718. In a specific implementation, the supplementary support provider record is generated based on provider input received by the supplementary support provider user interface engine 724 and/or the supplementary support provider network interface engine 726 of the supplementary support provider system 706 and delivered through the model and record communicating engine 714.

The supplementary support provider record repository 718 is intended to represent a datastore configured to store one or more supplementary support provider records including one or more supplementary support provider records generated by the supplementary support provider record processing engine 716. In a specific implementation, in storing one or more supplementary support provider records, the supplementary support provider record repository 718 manages the supplementary support provider records using a provider record table including a plurality of entries each of which corresponds to a supplementary support provider record. For example, an entry of the provider record table includes an identification of the supplementary support provider record, an identification of a supplementary support provider, attributes of the supplementary support provider (e.g., service field, service regions, fee structure, rating, etc.), and so on. In a specific implementation, in storing one or more supplementary support provider records, the supplementary support provider record repository 718 also stores a machine learning model applicable to one or more supplementary support provider records stored therein.

The supplementary support provider user interface engine 724 is intended to represent hardware configured to receive and forward provider input to the dynamic machine-learning-based pre-legal-filing self-service system 704.

The supplementary support provider network interface engine 726 is intended to represent hardware configured to receive and forward provider input to the dynamic machine-learning-based pre-legal-filing self-service system 704. In a specific implementation, the supplementary support provider network interface engine 726 communicates with an external provider device associated with the supplementary support provider system 706 and serves as an intermediary between the dynamic machine-learning-based pre-legal-filing self-service system 704 and the external provider device. In a specific implementation, the external practitioner device includes functionality substantially similar to that of the supplementary support provider user interface engine 724.

In an example of operation of the example system shown in FIG. 7, the dynamic service offer selection model managing engine 710 generates a dynamic service offer selection model, and stores the generated dynamic service offer selection model in the dynamic service offer selection model repository 712. Further, in the example of operation of the example system shown in FIG. 7, the dynamic service offer selection model managing engine 710 obtains a client record stored in the client record repository 722 and client input received from the client user interface engine 724 and/or the client network interface engine 726 through the model and record communicating engine 714, and determines a client's legal and/or psychological process stage based on the client record and/or the client input. Moreover, in the example of operation of the example system shown in FIG. 7, the dynamic service offer selection model managing engine 710 obtains supplementary support provider records of registered supplementary support providers stored in the supplementary support provider record repository 718 and obtain previous offer outcome records of supplementary support service offers associated with client record and/or the client input. Furthermore, in the example of operation of the example system shown in FIG. 7, the dynamic service offer selection model managing engine 710 determines supplementary support provider offers based on the client record, the client input, the supplementary support provider records, and/or the previous offer records, and provides the supplementary support provider offers to the client system 706. In the example of operation of the example system shown in FIG. 7, the supplementary support provider record processing engine 716 generates a supplementary support provider record based on provider input received from the supplementary support provider user interface engine 724 and/or the supplementary support provider network interface engine 726 through the model and record communicating engine 714, and stores the generated supplementary support provider record in the supplementary support provider record repository 718. In the example of operation of the example system shown in FIG. 7, the client record processing engine 720 generates a client record based on client input received from the client user interface engine 728 and/or the client network interface engine 730 through the model and record communicating engine 714, and stores the generated client record in the client record repository 722.

In the example of operation of the example system shown in FIG. 7, the supplementary support provider user interface engine 724 receives provider input and forwards the received provider input to the dynamic machine-learning-based pre-legal-filing self-service system 704 through the model and record communicating engine 714 thereof. In the example of operation of the example system shown in FIG. 7, the supplementary support provider network interface engine 726 receives provider input and forwards the received provider input to the dynamic machine-learning-based pre-legal-filing self-service system 704 through the model and record communicating engine 714 thereof.

In the example of operation of the example system shown in FIG. 7, the client user interface engine 728 receives client input and forwards the received client input to the dynamic machine-learning-based pre-legal-filing self-service system 704 through the model and record communicating engine 714 thereof. Further, in the example of operation of the example system shown in FIG. 7, the client user interface engine 728 presents the supplementary support provider offers received from the dynamic machine-learning-based pre-legal-filing self-service system 704 on a GUI generated thereby. In the example of operation of the example system shown in FIG. 7, the client network interface engine 730 receives client input and forwards the received client input to the dynamic machine-learning-based pre-legal-filing self-service system 704 through the model and record communicating engine 714 thereof. Further, in the example of operation of the example system shown in FIG. 7, the client network interface engine 730 forwards the supplementary support provider offers received from the dynamic machine-learning-based pre-legal-filing self-service system 704 for display on a GUI generated by a coupled user device.

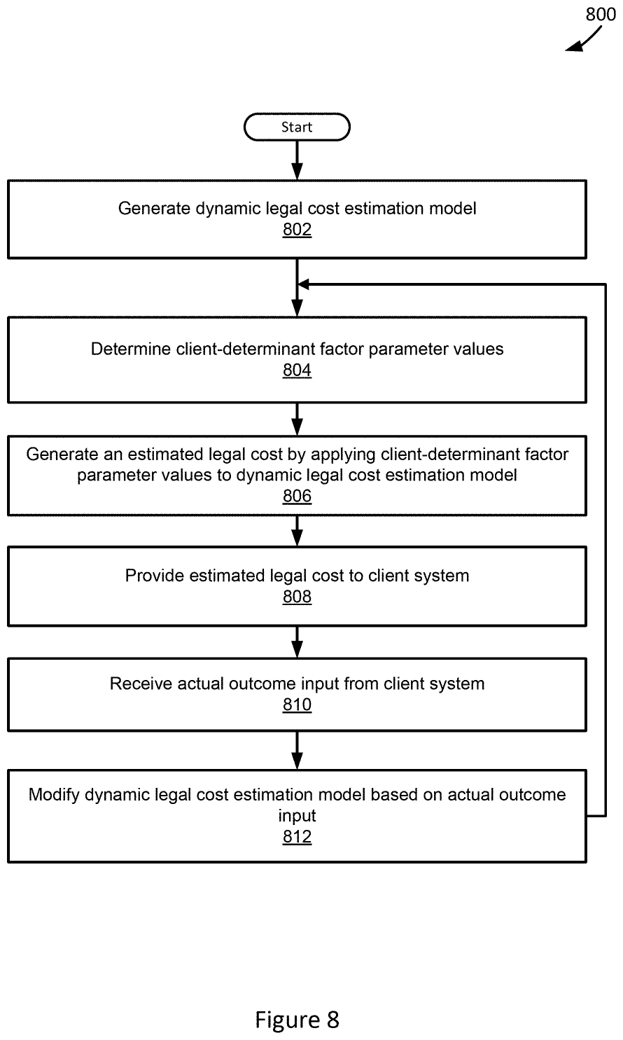

FIG. 8 depicts a flowchart 800 of an example of a method for providing an estimated legal cost to a client system based on a dynamic legal cost estimation model. This flowchart and the other flowcharts described in this paper illustrate modules (and potentially decision points) organized in a fashion that is conducive to understanding. It should be recognized, however, that the modules can be reorganized for parallel execution, reordered, modified (changed, removed, or augmented), where circumstances permit. The flowchart 800 begins at module 802 with generating a dynamic legal cost estimation model. An applicable engine such as the dynamic legal cost estimation model generating engine 208 in FIG. 2 generates a dynamic legal cost estimation model.

The flowchart 800 continues to module 804 with determining client-determinant factor parameter values. An applicable engine such as the dynamic legal cost estimation model generating engine 208 in FIG. 2 determines client-determinant factor parameter values based on client input. In a specific implementation, the client input is received by an applicable engine, such as the client user interface engine 218 and/or the client network interface engine 220 FIG. 2, and is delivered through an applicable engine such as the model and record communicating engine 212 in FIG. 2.

The flowchart 800 continues to module 806 with generating an estimated legal cost by applying client-determinant factor parameter values to a dynamic legal cost estimation model. An applicable engine such as the dynamic legal cost estimation model generating engine 208 in FIG. 2 generates an estimated legal cost by applying client-determinant factor parameter values to a dynamic legal cost estimation model.

The flowchart 800 continues to module 808 with providing an estimated legal cost to a client system. An applicable engine such as the dynamic legal cost estimation model generating engine 208 in FIG. 2 provides an estimated legal cost to a client system (e.g., the client system 206 in FIG. 2) through an applicable engine such as the model and record communicating engine 212 in FIG. 2.

The flowchart 800 continues to module 810 with receiving actual outcome input from a client system. An applicable engine such as the client user interface engine 218 and/or the client network interface engine 220 in FIG. 2 receives the actual outcome input, and delivers through an applicable engine such as the model and record communicating engine 212 in FIG. 2.

The flowchart 800 continues to module 812 with modifying a dynamic legal cost estimation model based on actual outcome input. An applicable engine such as the dynamic legal cost estimation model generating engine 208 in FIG. 2 modifies a dynamic legal cost estimation model based on actual outcome input. In a specific implementation, the dynamic legal cost estimation model is modified by employing an applicable machine learning algorithm, such as a decision tree learning, association rule learning, artificial neural networks, deep learning, etc. Upon completion of module 812, the flowchart 800 returns to module 804 for a new client or a new legal case.

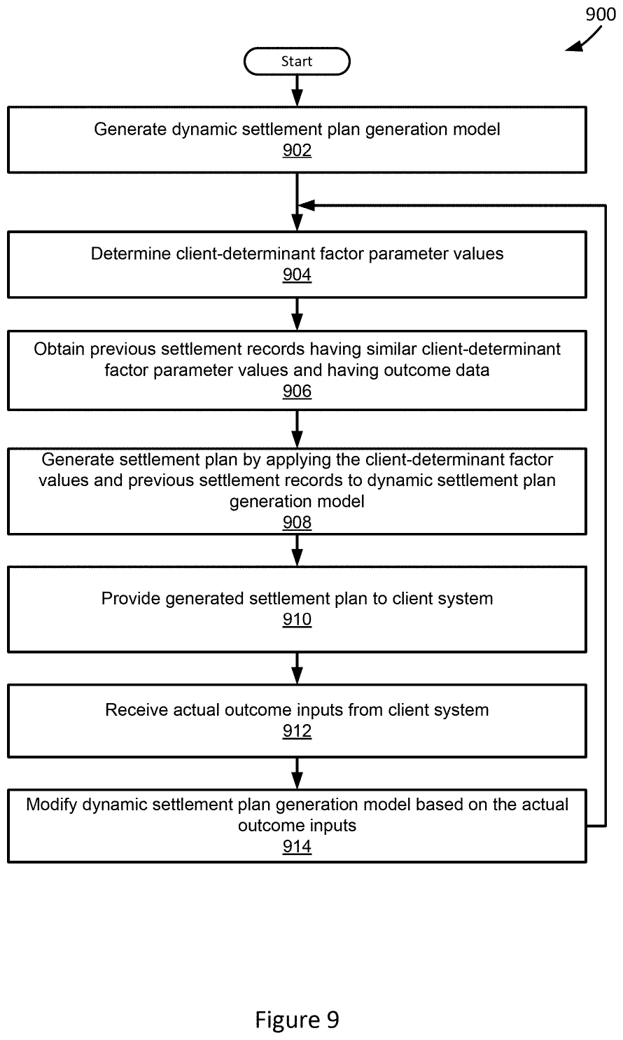

FIG. 9 depicts a flowchart 900 of an example of a method for providing a settlement plan to a client system based on a dynamic settlement plan generation model. The flowchart 900 begins at module 902 with generating a dynamic settlement plan generation model. An applicable engine such as the dynamic settlement plan generation model generating engine 308 in FIG. 3 generates a dynamic settlement plan generation model.

The flowchart 900 continues to module 904 with determining client-determinant factor parameter values. An applicable engine such as the dynamic settlement plan generation model generating engine 308 in FIG. 3 determines the client-determinant factor parameter values based on client input. In a specific implementation, the client input is received by an applicable engine, such as the client user interface engine 318 and/or the client network interface engine 320 in FIG. 3, and is delivered through an applicable engine such as the model and record communicating engine 312 in FIG. 3.

The flowchart 900 continues to module 906 with obtaining previous settlement records having similar client-determinant factor parameter values and having outcome data. An applicable engine such as the dynamic settlement plan generation model generating engine 308 in FIG. 3 obtains previous settlement records having similar client-determinant factor parameter values and having outcome data from an applicable source, such as the client record repository 316 in FIG. 3.

The flowchart 900 continues to module 908 with generating a settlement plan by applying the client-determinant factor values and historic settlement records to a dynamic settlement plan generation model. An applicable engine such as the dynamic settlement plan generation model generating engine 308 in FIG. 3 generates a settlement plan by applying the client-determinant factor values and historic settlement records to the dynamic settlement plan generation model.

The flowchart 900 continues to module 910 with providing the generated settlement plan to a client system. An applicable engine such as the dynamic settlement plan generation model generating engine 308 in FIG. 3 provides a settlement plan to a client system (e.g., the client system 306 in FIG. 3) through an applicable engine such as the model and record communicating engine 312 in FIG. 3.

The flowchart 900 continues to module 912 with receiving actual outcome input from a client system. An applicable engine such as the client user interface engine 318 and/or the client network interface engine 320 in FIG. 3 receives the actual outcome input, and delivers through an applicable engine such as the model and record communicating engine 312 in FIG. 3.

The flowchart 900 continues to module 914 with modifying a dynamic settlement plan generation model based on the actual outcome input. An applicable engine such as the dynamic settlement plan generation model generating engine 308 in FIG. 3 modifies a dynamic settlement plan generation model based on actual outcome input. In a specific implementation, the dynamic settlement plan generation model is modified by employing an applicable machine learning algorithm, such as a decision tree learning, association rule learning, artificial neural networks, deep learning, etc. Upon completion of module 914, the flowchart 900 returns to module 904 for a new client or a new legal case.

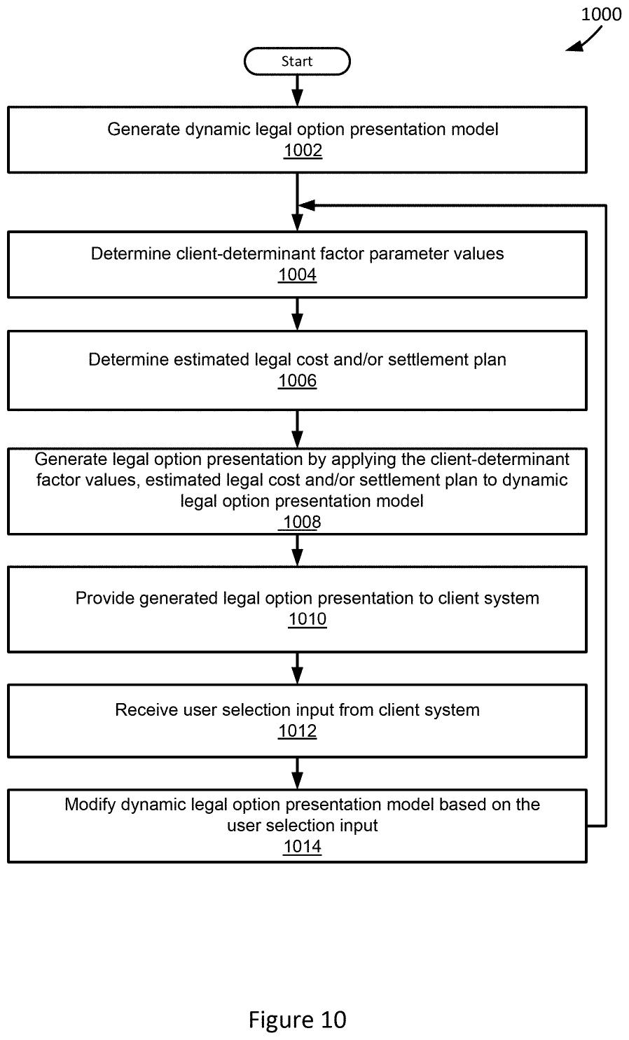

FIG. 10 depicts a flowchart 1000 of an example of a method for providing a legal option presentation to a client system based on a dynamic legal option presentation generation model. The flowchart 1000 begins at module 1002 with generating a dynamic legal option presentation model. An applicable engine such as the dynamic legal option presentation model generating engine 408 in FIG. 4 generates a dynamic legal option presentation model.

The flowchart 1000 continues to module 1004 with determining client-determinant factor parameter values. An applicable engine such as the dynamic legal option presentation model generating engine 408 in FIG. 4 determines the client-determinant factor parameter values based on client input. In a specific implementation, the client input is received by an applicable engine, such as the client user interface engine 422 and/or the client network interface engine 424 FIG. 4, and is delivered through an applicable engine such as the model and record communicating engine 412 in FIG. 4.

The flowchart 1000 continues to module 1006 with determining an estimated legal cost and/or a settlement plan. An applicable engine such as the model and record communicating engine 412 in FIG. 4 determines an estimated legal cost and/or a settlement plan through an applicable process, e.g., the module 806 in FIG. 8 and/or the module 908 in FIG. 9.

The flowchart 1000 continues to module 1008 with generating a legal option presentation by applying the client-determinant factor values, estimated legal cost and/or settlement plan to a dynamic legal option presentation model. An applicable engine such as the dynamic legal option presentation model generating engine 408 in FIG. 4 generates a legal option presentation by applying the client-determinant factor values, estimated legal cost and/or settlement plan to a dynamic legal option presentation model.

The flowchart 1000 continues to module 1010 with providing a generated legal option presentation to a client system. An applicable engine such as the dynamic legal option presentation model generating engine 408 in FIG. 4 provides an estimated legal cost to a client system (e.g., the client system 406 in FIG. 4) through an applicable engine such as the model and record communicating engine 412 in FIG. 4.

The flowchart 1000 continues to module 1012 with receiving client selection input from a client system. An applicable engine such as the client user interface engine 422 and/or the client network interface engine 424 in FIG. 4 receives client selection input.

The flowchart 1000 continues to module 1014 with modifying a dynamic legal option presentation model based on the client selection input. An applicable engine such as the dynamic legal option presentation model generating engine 408 in FIG. 4 modifies a dynamic legal option presentation model based on the client selection input. In a specific implementation, the dynamic legal option presentation model is modified by employing an applicable machine learning algorithm, such as a decision tree learning, association rule learning, artificial neural networks, deep learning, etc. Upon completion of module 1014, the flowchart 1000 returns to module 1004 for a new client or a new legal case.

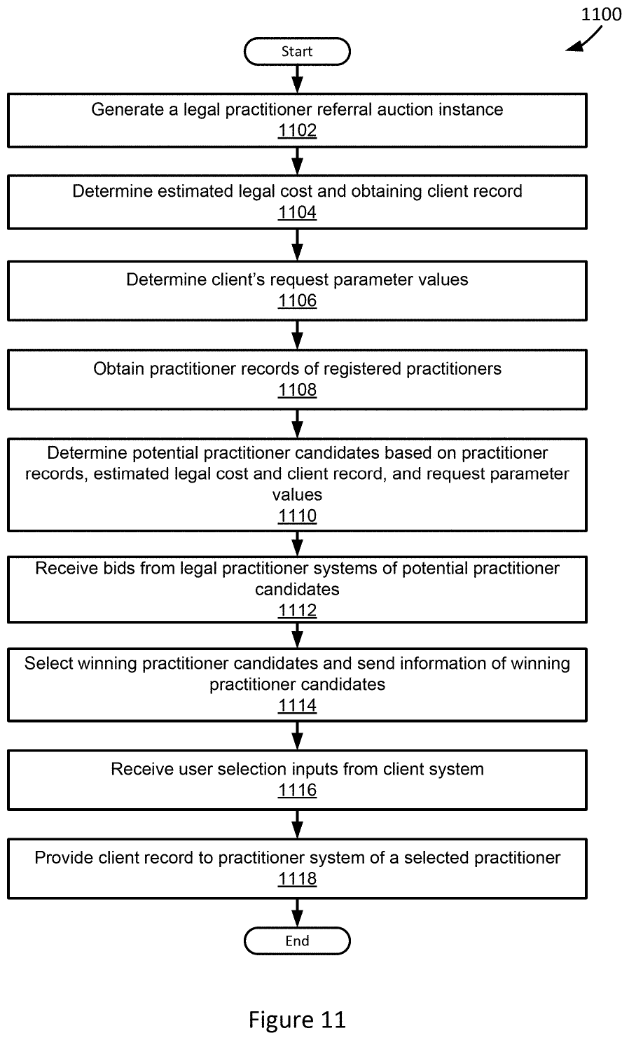

FIG. 11 depicts a flowchart 1100 of an example of a method for managing a legal practitioner referral auction. The flowchart 1100 begins at module 1102 with generating a legal practitioner referral auction instance. An applicable engine such as the referral auction managing engine 510 in FIG. 5 generates a legal practitioner referral auction instance.

The flowchart 1100 continues to module 1104 with determining an estimated legal cost and obtaining a client record. An applicable engine such as the referral auction managing engine 510 in FIG. 5 determines an estimated legal cost through an applicable process such as the module 806 in FIG. 8 and obtains a client record from an applicable source such as the client record repository 516 in FIG. 5.

The flowchart 1100 continues to module 1106 with determining client's request parameter values. An applicable engine such as the referral auction managing engine 510 in FIG. 5 determines client's request parameter values based on client input received by an applicable engine such as the client user interface engine 522 and/or the client network interface engine 524 in FIG. 5 and delivered through an applicable engine such as the auction data communicating engine 512 in FIG. 5.

The flowchart 1100 continues to module 1108 with obtaining practitioner records of registered legal practitioners. An applicable engine such as the referral auction managing engine 510 in FIG. 5 obtains practitioner records of registered legal practitioners from an applicable source, such as the practitioner record repository 520 in FIG. 5.

The flowchart 1100 continues to module 1110 with determining potential practitioner candidates based on practitioner records, estimated legal cost and client record, and request parameter values. An applicable engine such as the referral auction managing engine 510 in FIG. 5 determines potential practitioner candidates based on practitioner records, estimated legal cost and client record, and request parameter values. In a specific implementations, auction invitations are provided to legal practitioner systems (e.g., the legal practitioner systems 508 in FIG. 5) of the potential practitioner candidates through an applicable engine, such as the auction data communicating engine 512 in FIG. 5.

The flowchart 1100 continues to module 1112 with receiving bids from legal practitioner systems of legal practitioner candidates. An applicable engine such as the referral auction managing engine 510 in FIG. 5 receiving bids from legal practitioner systems (e.g., the legal practitioner systems 508 in FIG. 5) of legal practitioner candidates, through an applicable engine, such as the auction data communicating engine 512 in FIG. 5.

The flowchart 1100 continues to module 1114 with selecting winning practitioner candidates and sending information of winning practitioner candidates. An applicable engine such as the referral auction managing engine 510 in FIG. 5 selects winning practitioner candidates and sends information of winning practitioner candidates to legal practitioner systems (e.g., the legal practitioner systems 508 in FIG. 5) of the winning practitioner candidates through an applicable engine, such as the auction data communicating engine 512 in FIG. 5.

The flowchart 1100 continues to module 1116 with receiving client selection input from a client system. An applicable engine such as the referral auction managing engine 510 in FIG. 5 receives client selection input from a client system (e.g., the client system 506 in FIG. 5) through an applicable engine, such as the auction data communicating engine 512 in FIG. 5. In a specific implementation, the client selection input indicates a winning legal practitioner selected by a client associated with the client system.

The flowchart 1100 ends at module 1118 with providing a client record to a practitioner system of a winning legal practitioner. An applicable engine such as the referral auction managing engine 510 in FIG. 5 provides a client record of a client who selected the winning legal practitioner to the practitioner system (e.g., the legal practitioner systems 508 in FIG. 5) of the winning practitioner through an applicable engine, such as the auction data communicating engine 512 in FIG. 5.

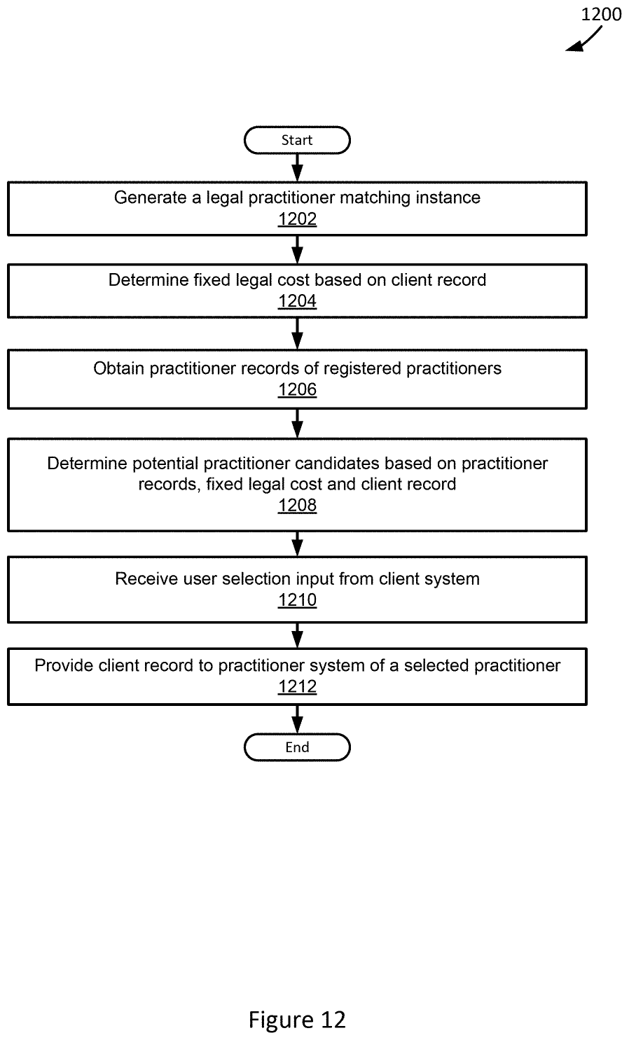

FIG. 12 depicts a flowchart 1200 of an example of a method for managing legal practitioner matching. The flowchart 1200 begins at module 1202 with generating a legal practitioner matching instance. An applicable engine such as the practitioner matching managing engine 610 in FIG. 6 generates a legal practitioner matching instance.

The flowchart 1200 continues to module 1204 with determining a fixed legal cost based on a client record. An applicable engine such as the practitioner matching managing engine 610 in FIG. 6 determines a fixed legal cost based on a client record obtained from an applicable source such as the client record repository 616 in FIG. 6.

The flowchart 1200 continues to module 1206 with obtaining practitioner records of registered legal practitioners. An applicable engine such as the practitioner matching managing engine 610 in FIG. 6 obtains practitioner records of registered legal practitioners from an applicable source, such as the practitioner record repository 620 in FIG. 6.

The flowchart 1200 continues to module 1208 with determining potential practitioner candidates based on practitioner records, a fixed legal cost, and a client record. An applicable engine such as the practitioner matching managing engine 610 in FIG. 6 determines potential practitioner candidates based on practitioner records, a fixed legal cost, and a client record.

The flowchart 1200 continues to module 1210 with receiving client selection input from a client system. An applicable engine such as the practitioner matching managing engine 610 in FIG. 6 receives client selection input from a client system (e.g., the client system 606 in FIG. 6) through an applicable engine, such as the matching data communicating engine 612 in FIG. 6. In a specific implementation, the client selection input indicates a legal practitioner selected by a client associated with the client system.

The flowchart 1200 ends at module 1212 with providing a client record to practitioner system of a selected practitioner. An applicable engine such as the practitioner matching managing engine 610 in FIG. 6 provides a client record of a client who selected the legal practitioner to the practitioner system (e.g., the legal practitioner systems 508 in FIG. 5) of the practitioner through an applicable engine, such as the matching data communicating engine 612 in FIG. 6.

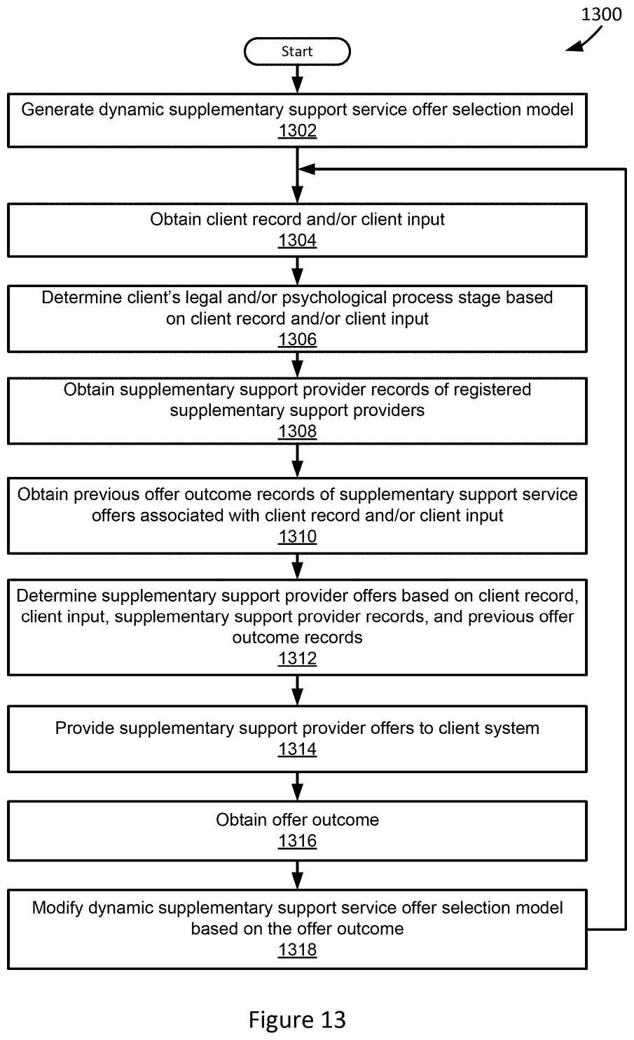

FIG. 13 depicts a flowchart 1300 of an example of a method for providing supplementary support provider offers to a client system based on a dynamic supplementary support service offer selection model. The flowchart 1300 begins at module 1302 with generating a dynamic supplementary support service offer selection model. An applicable engine such as the dynamic service offer selection model managing engine 710 in FIG. 7 generates a dynamic supplementary support service offer selection model.

The flowchart 1300 continues to module 1304 with obtaining a client record and/or client input. An applicable engine such as the dynamic service offer selection model managing engine 710 in FIG. 7 obtains a client record and/or client input of a client from an applicable source, such as the client record repository 722 in FIG. 7.

The flowchart 1300 continues to module 1306 with determining a client's legal and/or psychological process stage based on a client record and/or client input. An applicable engine such as the dynamic service offer selection model managing engine 710 in FIG. 7 determines a client's legal and/or psychological process stage based on a client record and/or client input. In a specific implementation, the client input is received by an applicable engine, such as the client user interface engine 728 and the client network interface engine 730 in FIG. 7, and delivered through an applicable engine such as the model and record communicating engine 714 in FIG. 7.

The flowchart 1300 continues to module 1308 with obtaining supplementary support provider records of registered supplementary support providers. An applicable engine such as the dynamic service offer selection model managing engine 710 in FIG. 7 obtains supplementary support provider records of registered supplementary support providers from an applicable source, such as the supplementary support provider record repository 718 in FIG. 7.

The flowchart 1300 continues to module 1310 with obtaining previous offer outcome records of supplementary support service offers associated with a client record and/or client input. An applicable engine such as the dynamic service offer selection model managing engine 710 in FIG. 7 obtains previous offer outcome records of supplementary support service offers from an applicable source, such as the supplementary support provider record repository 718 and/or the client record repository 722 in FIG. 7.

The flowchart 1300 continues to module 1312 with determining supplementary support provider offers based on a client record, client input, supplementary support provider records, and previous offer records. An applicable engine such as the dynamic service offer selection model managing engine 710 in FIG. 7 determines the supplementary support providers.

The flowchart 1300 continues to module 1314 with providing supplementary support provider offers to a client system. An applicable engine such as the dynamic service offer selection model managing engine 710 in FIG. 7 provides supplementary support provider offers to a client system (e.g., the client system 708 in FIG. 7) through an applicable engine such as the model and record communicating engine 714 in FIG. 7.

The flowchart 1300 continues to module 1316 with obtaining an offer outcome. An applicable engine such as the dynamic service offer selection model managing engine 710 in FIG. 7 obtains the offer outcome from an applicable source such as the supplementary support provider system 706, the client system 708, and/or any other sources.

The flowchart 1300 continues to module 1318 with modifying a dynamic supplementary support service offer selection model based on the offer outcome. An applicable engine such as the dynamic service offer selection model managing engine 710 in FIG. 7 modifies a dynamic supplementary support service offer selection model based on the offer outcome. In a specific implementation, the dynamic supplementary support service offer selection model is modified by employing an applicable machine learning algorithm, such as a decision tree learning, association rule learning, artificial neural networks, deep learning, etc. Upon completion of module 1318, the flowchart 1300 returns to module 1304 for a new client or a new legal case.

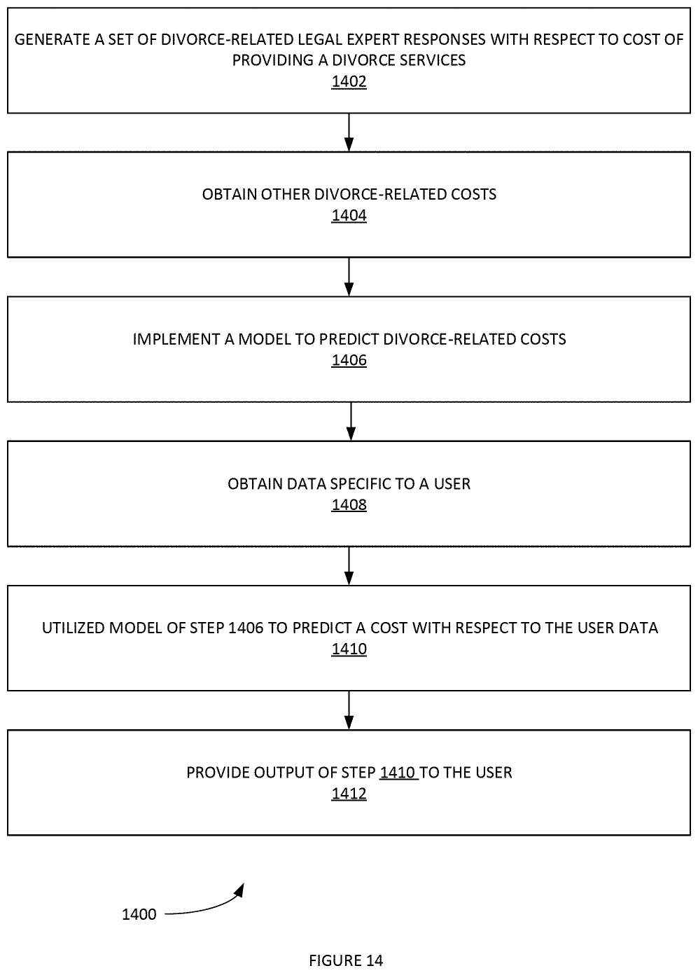

FIG. 14 illustrates an example process 1400 for providing an estimated legal cost to a client system based on a dynamic legal cost estimation model, according to some embodiments. In one example, the legal cost can be for an end-to-end legal process (e.g. pre-trial motions, trials, discovery, etc.) and/or any portion thereof.

In step 1402, process 1400 can generate a set of divorce-related legal expert responses with respect to cost of providing a divorce services. This can be obtained using online surveys to attorneys, non-profit organizations, legal associations, etc.

In step 1404, process 1400 can obtain other divorce-related costs (e.g. filing fees, service of process fees, appraisal fees, etc.). This information can be obtained via web crawlers, scrappers, APIs, etc. The data obtain from steps 1402 and 1404 can be parsed and stored in a data store. Various preparatory steps can be implemented as well. These can include data transformations, removal of outliers, NLP analysis, data normalization, etc.

In step 1406, process 1400 can implement a model to predict divorce-related costs. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. An example predictive model is provided in process 1500 infra. Machine learning techniques can be selected based on various factors such as the size of the data store generated by steps 1402 and 1404, type of data generated by steps 1402 and 1404, desired confidence intervals of predictions, computational time constraints, etc. This can the dynamic legal cost estimation model provided supra. This can be used to determine a set of client-determinant factor parameter values.

In step 1408, process 1400 can obtain data specific to a user. For example, users can upload information that is relevant to a divorce proceeding to a website and/or application implementing process 1400. Example user data can include, inter alia: value of user assets, user employment status, user emotional state, user income (e.g. income of both spouses), number of children in home, child age, personal and community debts, applicable state laws, estimates of how cooperative opposing spouse will be during proceedings, etc. This data can match the variables of the set of client-determinant factor parameter values.

In step 1410, process 1400 can utilize the model of step 1406 to predict a cost with respect to the user data provided in step 1408. In step 1412, process 1400 can provide output of step 1410 to the user.

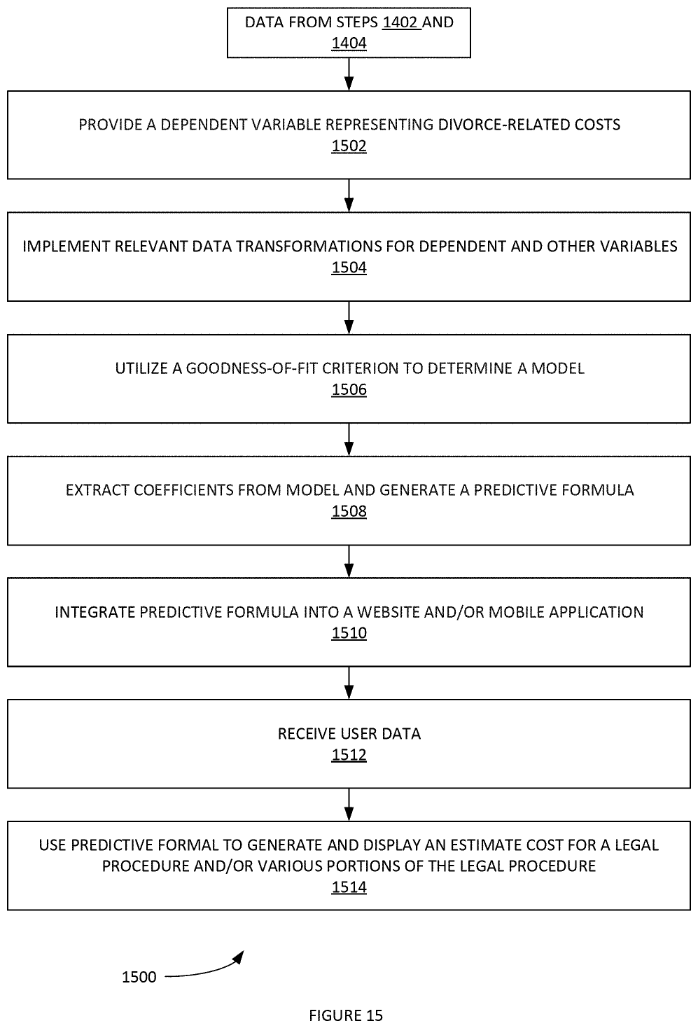

FIG. 15 illustrates an example process 1500 for generating and utilizing a model for estimating a legal cost, according to some embodiments. In step 1502, process 1500 can obtain data from steps 1402 and 1404. In other examples, this data can also include court fees, surveys of attorney data, etc. In step 1504, process 1500 can provide a dependent variable representing divorce-related cost factors. In step 1506, process 1500 can implement relevant data transformations for dependent and other variables. In step 1508, process 1500 can utilize a goodness-of-fit criterion to determine a model. In step 1510, process 1500 can extract coefficients from model and generate a predictive formula. In step 1512, process 1500 can integrate predictive formula into a website and/or mobile application. Instep 1514, process 1500 can receive user data. In step 1514, process 1500 can use predictive formal to generate and display an estimate cost for a legal procedure and/or various portions of the legal procedure.

An example of process 1500 is now provided. Relevant case data can be gathered from a set of subject matter experts (e.g. attorneys, researchers, professors, etc.) using a digital questionnaire. A dataset which can be assembled from the subject matter expert responses. A dependent variable can (e.g. “BillableHoursAttorney”) determined. The dependent variable can be related to the cost of the legal proceeding. The dependent variable can be log-transformed to be more Gaussian so that it can be with a linear regression model. Other variables can also be log-transformed (e.g. user home value, other asset values, etc.). Some categorical variables can be re-leveled in order to set a baseline level at an appropriate state as a default. For example, for a variable relating to control of accounts, it can re-leveled so that the baseline is “joint control” as opposed to one or the other spouses.

An AIC goodness-of-fit criterion can then be implemented to determine which model was the most parsimonious. In this way, various variables can be added and it can be determined whether each one was a net increase or decrease per the AIC criterion (e.g. the AIC is minimized). After settling on a set of main effects, any interactions between the main effects can be determined and added to the model if they too decrease the AIC criterion. In this way, the model can be fit without an intercept so that the resulting formula can express the results in terms of a sum of the variable of the effects (e.g. not expressed as an offset from a particular baseline scenario). An example equation for the model is as follows:

model=log(billableHoursAttorney)˜workStatus+income+hasCommissionOrBonus+creditCardDebt+various variables that measure spousal cooperativity(e.g. IsCooperativeHome,isCooperativeFinancial,isCooperativeDebt,isCooperativeDebt,etc.)+ChildSupportEstimatations+alreadyWorkedOutDebt+currentFeelingAboutDivorce−1

It is noted that these equations and variables are provided by way of example and not of limitation. In other example embodiments, other variables can be utilized.

It is noted that processes 800, 1400 and 1500 can be modified for non-divorce legal proceedings such as, inter alia: civil litigation, criminal defense, land use/zoning proceedings, intellectual property matters, etc. Modified versions of processes 800, 1400 and 1500 can be implemented by the relevant systems provided herein as well.

It is noted that, after a year or some other reasonable period, automatic surveys can be communicated to user customers who completed their filings to obtain feedback on how satisfied they were with how their divorce was settled. The automatic surveys can include questions on how satisfied the user customer was with the results provided by specific modules. This information can be used to update the various prediction models utilized herein. For example, the automatic surveys can be used to refine prediction models for what settlement options and/or costs are presented to better reflect those that lead to long term satisfaction among customers. Feedback can also be received from court systems or from attorney/mediator case management software. This feedback can also be used to refine prediction models. For example, a legal proceedings cost prediction can be referred an attorney. After the case was completed, the attorney can provide feedback indicating the time/cost (e.g. total number of billable hours, etc.) and what the final settlement was. This can be used to improve predication models as well.

Additionally, the processes provided herein can include an option to donate items to charity that neither spouse wishes to keep. Customers can be algorithmically matched with appropriate charities who would receive the donated items. Furthermore, a coin-flip functionality can be used to determine ownership of minor items.

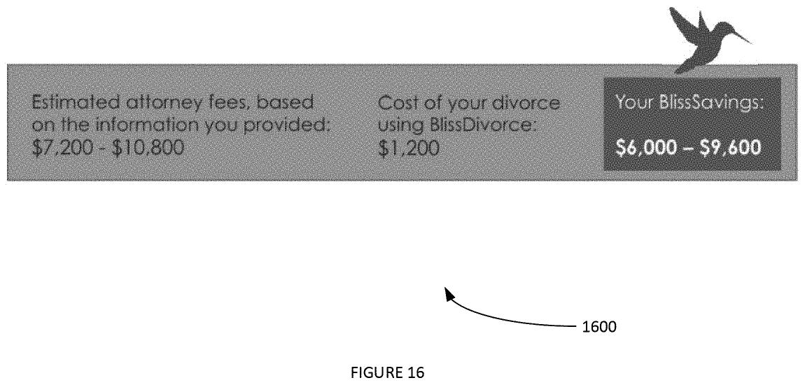

FIG. 16 illustrates an example user-interface display 1600 of an estimated legal cost, according to some embodiments. Display 1600 can be displayed by a client system (e.g. a mobile device display, a personal computer display, etc.). The information in display 1600 can be generated by the processes 800, 1400 and/or 1500. The information can be based on a dynamic legal cost estimation model.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computerized method for providing an estimated legal cost to a client system based on a dynamic legal cost estimation model comprising:
generating a dynamic legal cost estimation model;
determining a set of client-determinant factor parameter values;
generating an estimated legal cost by applying the set of client-determinant factor parameter values to the dynamic legal cost estimation model;
providing an estimated legal cost to the client system;
receiving an actual outcome input from the client system; and
modifying the dynamic legal cost estimation model based on the actual outcome input.

2. The computerized method of claim 1, wherein a dynamic legal cost estimation model generating engine generates the dynamic legal cost estimation model.

3. The computerized method of claim 2, wherein the dynamic legal cost estimation model generating engine determines the client-determinant factor parameter values based on client input into a client-side computing system.

4. The computerized method of claim 3, wherein the dynamic legal cost estimation model generating engine generates the estimated legal cost by applying a set of client-determinant factor parameter values to the dynamic legal cost estimation model.

5. The computerized method of claim 4, wherein the dynamic legal cost estimation model generating engine provides the estimated legal cost to the client system using a model and record communicating engine.

6. The computerized method of claim 5, wherein the dynamic legal cost estimation model is modified by employing an applicable machine learning algorithm.

7. The computerized method of claim 6, wherein the machine learning algorithm comprises a linear regression model.

8. The computerized method of claim 6, wherein the machine learning algorithm comprises a decision tree learning, an association rule learning or an artificial neural networks.

9. A computerized system useful for providing an estimated legal cost to a client system based on a dynamic legal cost estimation model comprising:
at least one processor configured to execute instructions;
at least one memory containing instructions when executed on the at least one processor, causes the at least one processor to perform operations that:
generate a dynamic legal cost estimation model;
determine a set of client-determinant factor parameter values;
generate an estimated legal cost by applying the set of client-determinant factor parameter values to the dynamic legal cost estimation model; and
provide an estimated legal cost to the client system.

10. The computerized system of claim 9, wherein the at least one memory containing instructions when executed on the at least one processor, further causes the at least one processor to perform operations that:
receive an actual outcome input from the client system.

11. The computerized system of claim 10, wherein the at least one memory containing instructions when executed on the at least one processor, further causes the at least one processor to perform operations that:
modify the dynamic legal cost estimation model based on the actual outcome input.

12. The computerized system of claim 11, wherein the dynamic legal cost estimation model is modified by employing an applicable machine learning algorithm.

13. The computerized system of claim 12, wherein the machine learning algorithm comprises a linear regression model.

14. The computerized system of claim 13, wherein the machine learning algorithm comprises a decision tree learning, an association rule learning or an artificial neural networks.

15. A computerized method for providing an estimated legal cost to a client system based on a dynamic legal cost estimation model comprising:
obtaining a dataset of divorce-related legal expert responses with respect to cost of providing a divorce services;
implement a model to predict divorce-related costs;
obtaining a set of data specific to a user;
utilizing the model to predict a cost of the divorce-related costs with respect to the user data;
displaying the predicted cost of the divorce-related costs to the user.

16. The computerized method of claim 15 further comprising:
providing a set of dependent variables to the model, wherein the set of dependent variables each represents a specified divorce-related cost factor; and
implementing a relevant data transformation on the dependent variables.

17. The computerized method of claim 16 further comprising:
utilizing a goodness-of-fit criterion to determine the model; and
extracting a set of coefficients from the model.

18. The computerized method of claim 17 further comprising:
generating a predictive formula;
integrating predictive formula into a user-side application;
receiving a set of user data relevant to the specified divorce-related cost factors.
